(19) United States
(12) Patent Application Publication
(10) Pub. No.: US 2002/0111824 A1
(43) Pub. Date: Aug. 15, 2002

(54) Method of defining workflow rules for managing intellectual property

(75) Inventor: Jeffry J. Grainger, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First to File, Inc., Menlo Park, CA (US)

(21) Appl. No.: 09/996,077

(22) Filed: Nov. 27, 2001

Related U.S. Application Data
(60) Provisional application No. 60/253,360, filed on Nov. 27, 2000.

(51) Int. Cl. G06F 17/60

(52) U.S. Cl. 705/1

(57) ABSTRACT

A computer-implemented method of managing documents related to a patent application. In one embodiment the method includes storing a first workflow rule on a server system where the first workflow rule causes the server system to generate a message that requests approval to prepare a patent application for an invention disclosure and route the message to a second client system upon receipt of a first signal indicating a request to submit the invention disclosure for approval. The method also includes storing a first invention disclosure in a database accessible by said server system; receiving, at the server system, a first signal from a first client system indicating a request to submit the first invention disclosure for approval. Upon receipt of the first signal, the server system then executes the first workflow rule to generate a message requesting approval of a second client system to prepare a patent application from the first invention disclosure and communicate the message to the second client system.

### CROSS-REFERENCES TO RELATED APPLICATIONS

This application claims priority to U.S. Provisional Application No. 60/253,360, filed Nov. 27, 2000, the disclosure of which is hereby incorporated by reference in its entirety.

### BACKGROUND OF THE INVENTION

The present invention relates to managing intellectual property. More particularly, embodiments of the present invention relate to a computer-implemented method of facilitating the preparation of intellectual property documents, such as patent applications, securing intellectual property rights and managing intellectual property assets, including pending patent applications and issued or granted patents.

As the world economy has become more information and technology oriented, patents and other intellectual property are of growing importance. In order to secure such intellectual property rights appropriate paperwork needs to be completed and filed in an intellectual property office. For example, in order to secure patent protection within the U.S., a patent application describing and claiming an invention needs to be filed in the U.S. Patent and Trademark Office (hereinafter “USPTO”). Once filed, previously established rules and guidelines are followed by a Patent Examiner to determine whether or not patent rights to the invention should be granted. Typically, the process for obtaining these rights includes communications between the patentee and the patent office with many of such communications requiring a response within a given time period.

FIG. 1 is a diagram that illustrates a typical sequence of events and exchanges that occur between technology developers 2 and a Patent Office 6, such as the USPTO, in order to secure protection for a patent application. Also shown in FIG. 1 are patent attorneys and/or patent agents 4 along with their administrators (hereinafter referred to collectively as “patent practitioners”) that often represent technology developers 2 in patent procurement process. As used herein, technology developers are inventors, corporations and other entities that generate inventions and other ideas to be turned into patent applications (the technology creators). Also, a “patent office” is any patent office with the authority to receive patent filings for an individual country or collection of countries as provided for by various treaties or other compacts that countries may enter. Examples of patent offices include but are not limited to the U.S. Patent and Trademark Office, the European Patent Office, the German Patent Office, the Japanese Patent Office and any designated receiving office for patent applications filed under the Patent Cooperation Treaty.

As shown in FIG. 1, the patent process typically starts with the communication of an idea (invention) from a technology developer 2 (sometimes referred herein to as “Applicant”) to a patent practitioner 4. Such an idea is often communicated to patent practitioner 4 in the form of a written invention disclosure 10. The patent practitioner then prepares a patent application 12 that is filed, for example, in the USPTO. After the application is received by the USPTO and it is verified that all the necessary papers have been correctly completed, the application is examined by a patent examiner (hereinafter the “Examiner”). The Examiner then prepares and sends an Office Action 14 to patent practitioner 4 setting forth the USPTO's initial opinion on the patentability of the invention (of course, other papers, such as a Restriction Requirement or Notice of Allowance, may be prepared and sent instead of an Office Action as appropriate).

A Notification 16 of the Office Action is then forwarded to the Applicant who may prepare Instructions 18 to patent practitioner 4 so that the practitioner may prepare and file an appropriate Response 20. This Office Action 14/Response 20 cycle may be repeated one or more times until the Examiner mails a Notice of Allowance 22 indicating the patent application is in condition for allowance. A Notification 24 of the Notice of Allowance is mailed to Applicant 2 who then provide Instructions 26 to the patent practitioner 4 to transmit the Issue Fee 28 to the Patent Office. A couple of months after the Issue Fee is paid an Issued Patent 30 is published. U.S. Patent Law requires Maintenance Fees to be paid on an issued patent 3½, 7½ and 11 ½ years after issuance to maintain the patent in force. Practitioners 4 typically send Fee Reminders 32 to Applicants 2 about such maintenance fees. Applicants respond with Instructions 34 to ensure that Fees 36 are paid in a timely fashion.

Traditional methods of preparing, filing and examining patent applications and other intellectual property documents using a process identical to or similar to FIG. 1 have been centered around a paper-based methodology. Thus, throughout the above process, Applicants 2, patent practitioners 4 and Patent Office 6 each enter appropriate due dates and save papers they prepare in their internal databases 3, 5 and 7 respectively. For example, technology developers save invention disclosure 10 mn database 3; patent practitioners 4 save copies of patent application 12 and response to office action 20 in database 5; and patent offices 6 save office action 14 in database 7. Typically, such due dates are manually entered into a docketing database by a docketing clerk or other appropriate personnel.

Not shown in FIG. 1 are the various communications and exchanges between the inventor and practitioner, between the in-house practitioner and outside practitioner and between a foreign practitioner or agent and prosecuting practitioner or agent. Obtaining protection for a single patent application in multiple countries, i.e., prosecuting the application to issuance and paying necessary annuity and maintenance fees, typically involves over a hundred separate transactions between the applicant or inventor, practitioner and/or patent agents and the various patent offices.

In some instances (e.g., tracking annuity payments associated with foreign filings and tracking maintenance fees associated with issued U.S. patents), patent docketing responsibilities are transferred to an outside docketing service such as CPA or CPI. These services, however, generally do not interface well with law firms and/or technology developers. Generally these services maintain their own separate database for such docketed due dates.

In the year 2000, more than 300,000 patent applications were filed in the USPTO and approximately 2 million applications were filed in the patent offices associated with other countries. These numbers are expected to double by 2005. Some individual patent filers, for example, large law firms and large corporations, may file over a thousand applications themselves. Thus, as can be appreciated, tracking all the various due dates, communications and papers associated with such filings can be a tremendous burden.

In addition, as the number of invention disclosures, pending patent applications and issued patents increases, the ability of a technology developer manager to know and understand the contents of the technology developer's intellectual property portfolio decreases. While there are existing databases and other tools for storing intellectual property portfolio information, these databases typically include only bibliographic information regarding patents or patent applications and often require that information be manually entered by the user. Moreover, these database tools are often optimized for a particular purpose, such as docketing or annuity payments, and the various databases optimized for these purposes are often incompatible in data format and manner of usage. These databases and other tools limit technology developers' ability to know the contents and status of the assets in their intellectual property portfolios and thereby hinder their efforts in obtaining full value from their portfolios.

Furthermore, due to the increasing pace of technology development and an increased emphasis on obtaining full value from their patent portfolios, technology developers are placing more pressure on intellectual property managers to file greater numbers of patent applications. Shortages in trained patent practitioners, patent agents and other patent personnel, however, make it difficult to increase the number of patent applications prepared using current systems. There is therefore an acute need to increase the efficiency of current invention disclosure creation and patent application filing procedures as well as to improve the techniques used to manage intellectual property assets.

Accordingly, as can be seen from the above description, improved methods of facilitating the preparation of intellectual property documents, including patent applications, securing intellectual property rights and managing intellectual property assets, including pending patent applications and issued or granted patents are desirable.

### BRIEF SUMMARY OF THE INVENTION

Embodiments of the present invention solve the problems described above with respect to previously known methods of facilitating the preparation of, securing and managing intellectual property assets.

One embodiment of the method of the invention relates to managing documents related to a patent application. In this embodiment the method includes storing a first workflow rule on a server system where the first workflow rule causes the server system to generate a message that requests approval to prepare a patent application for an invention disclosure and route the message to a second client system upon receipt of a first signal indicating a request to submit the invention disclosure for approval. The method also includes storing a first invention disclosure in a database accessible by said server system; receiving, at the server system, a first signal from a first client system indicating a request to submit the first invention disclosure for approval. Upon receipt of the first signal, the server system then executes the first workflow rule to generate a message requesting approval of a second client system to prepare a patent application from the first invention disclosure and communicate the message to the second client system.

In another embodiment the method includes storing a first workflow rule on a server system, where the first workflow rule causes, upon receipt of a first signal indicating a request to submit a draft patent application for approval, the server system to generate a message that requests comments on the draft application and routes the message to a second client system. The method also includes storing a first draft patent application in a database accessible by the server system; receiving, at said server system, a first signal from a first client system indicating a request to solicit comments on the draft patent application; and executing the first workflow rule from the server system to generate a message requesting comments on the draft patent application from a second client system and communicate the message to the second client system.

These and other embodiments of the present invention, as well as its advantages and features, are described in more detail in conjunction with the text below and attached figures.

### BRIEF DESCRIPTION OF THE DRAWINGS

FIG. 1 is a diagram that illustrates a typical sequence of events involved in filing a patent application in a Patent Office, such as the U.S. Patent and Trademark Office;

FIG. 2 is a simplified block diagram showing the relationship between an intellectual property data processing system 100 according to one embodiment of the present invention and participants in the patent process;

FIGS. 3A-3L are example Web pages generated by IP data processing system 100 to facilitate the preparation of an Invention Disclosure according to one embodiment of the present invention;

FIG. 4A is an example of a Web page generated by IP data processing system 100 as the home page for an in-house practitioner client system according to one embodiment of the present invention;

FIGS. 4B-4G are example Web pages generated by IP data processing system 100 that are accessible to a client system through the home Web page shown in FIG. 4A according to one embodiment of the present invention;

FIG. 5 is a simplified block diagram of an intellectual property data processing system 200 according to a second embodiment of the present invention; and

FIG. 6 is an example of an alert message that can be automatically routed to a recipient client system according to one embodiment of the present invention.

### DETAILED DESCRIPTION OF THE INVENTION

The present invention provides a data processing system and a computer-implemented method of facilitating the preparation of intellectual property documents, such as patent applications, securing intellectual property rights and managing intellectual property assets, including pending patent applications and issued or granted patents. For convenience, the invention is described below with respect to filing, prosecuting and managing patent applications. It should be apparent that the present invention is not restricted to patent cases. It is to be understood, however, that the present invention is useful for managing other forms of intellectual property including trademarks and copyrights. Accordingly, the description of the present invention set forth below is not intended to limit the scope of the present invention in any way. One of ordinary skill in the art would recognize variations, modifications, and alternatives.

System Architecture and Overview

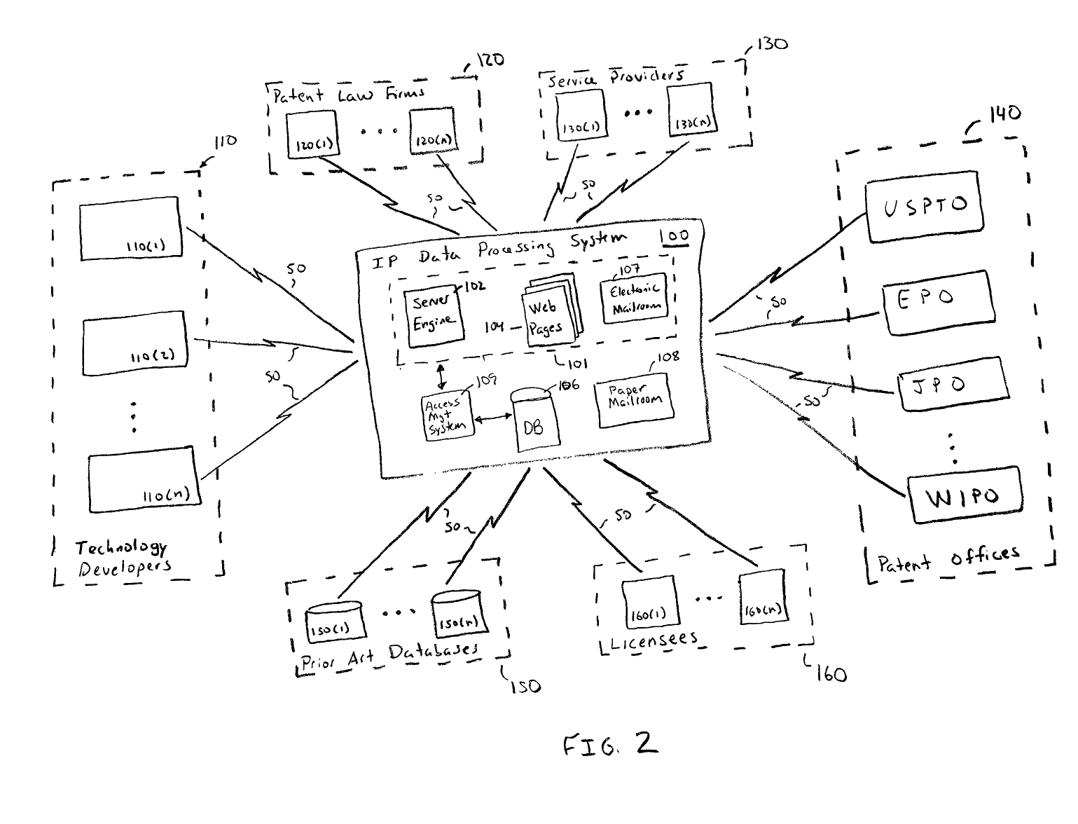

FIG. 2 is a simplified block diagram showing the relationship between an intellectual property (IP) data processing system 100 according to one embodiment of the present invention and participants in the patent process. The participants shown in FIG. 2 include technology developers 110, patent law firms 120, service providers 130, patent offices 140, prior art databases 150 and potential licensees 160. As described in detail below, IP data processing system 100 is a Web-enabled electronic platform that can be utilized by all participants in the patent process. Processing system 100 converts the paper-based patent prosecution system into an electronic workflow pipeline, allowing every step in the process to be executed from a computer desktop, slashing administrative costs and processing time for patent applications.

Processing system 100 provides technology developers 110 and associated patent law firms 120 a highly secure, central data repository that can be shared between participants on an as-allowed basis. Information generated and used during the patent prosecution process can be shared between a technology developer 110 and appropriate patent law firm 120 and service providers 130 in order to create patent filings, prosecute such filings through issuance and then subsequently maintain patents after grant. Some specific functions provided by IP data processing system 100 include:

online creation of invention disclosures, witnessing, archiving and secure sharing of invention disclosures between technology developers and patent counsel;

automated conversion of invention disclosures into patent applications and instant electronic filing of such applications in the PTO, giving inventions the earliest possible filing dates;

electronic filing and prosecution of patent applications in patent and offices worldwide, allowing all correspondence to and from patent offices to be paperless;

automated docketing in a standardized database accessible to all authorized participants, electronic notification of due dates and electronic payment of annuity fees;

IP portfolio visibility, on-demand status reporting, and strategic IP analysis, extending not only to issued patents, but to invention disclosures and pending applications as well;

data mining of IP portfolios and targeting of potential licensees;

online receipt and examination of patent applications and issuance of office actions by patent offices worldwide;

coordinating, tracking and providing payment options for all financial aspects of the patent process including patent office fees, practitioner fees and service provider fees.

As mentioned above, in addition to IP data processing system 100, FIG. 2 shows various patent process participants including technology developers 110, patent law firms 120, service providers 130, patent offices 140, prior art databases 150 and licensees 160 connected to IP data processing system 100 through the Internet 50. For convenience, each of these participants is referenced by a dotted line that encompasses individual entities of the participant type. For example, technology developers 110 are shown in FIG. 2 as including individual technology developers 110(1), 110(2) through 110(n). It is to be understood that, while shown in FIG. 2 as a group, these multiple technology developers are separate entities that likely have no relation to each other than their classification within this patent application as developers of technology. It is also to be understood that, while not shown, each individual participant system typically includes its own firewall system that implements access control functions to isolate the system from unwanted intrusions by others.

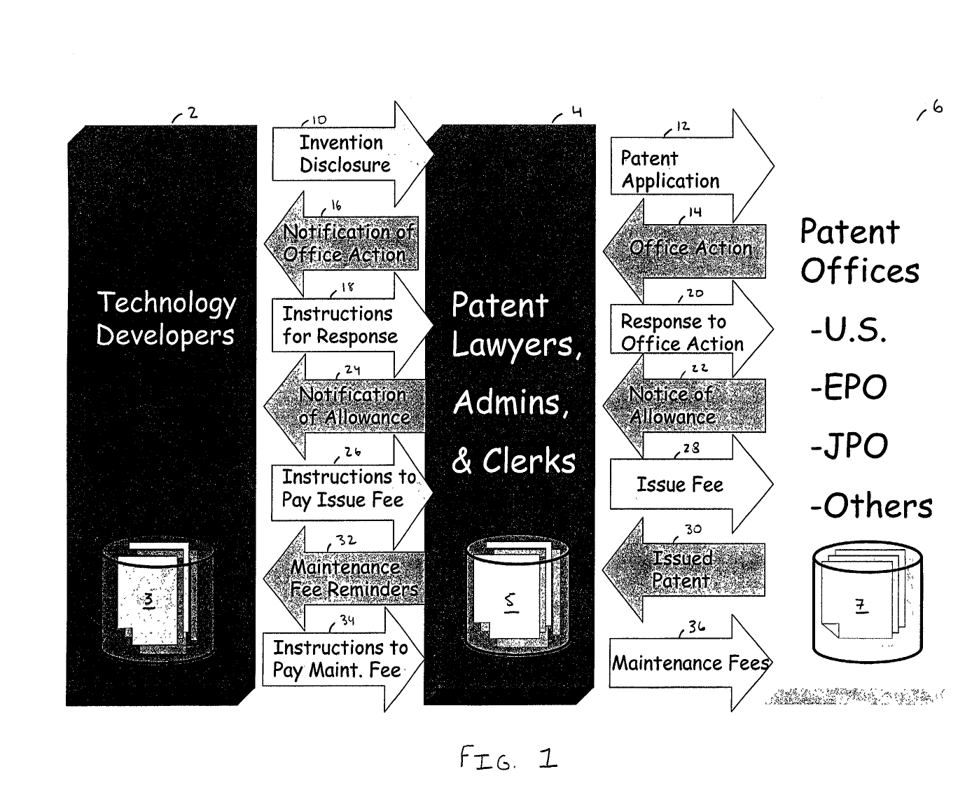

Internet 50 provides a mechanism allowing the various devices and computer systems depicted in FIG. 1 to communicate and exchange data and information with each other. Internet 50 may itself be comprised of many interconnected computer systems and communication links. While in one embodiment, participants communicate over the Internet, in other embodiments, communications between participants may occur over any suitable communication network including a local area network (LAN), a wide area network (WAN), a wireless network, an intranet, a private network, a public network, a switched network, an enterprise network, a virtual private network, and the like. Further, communications may occur over a combination of the various types of above mentioned networks.

Links used to connect the various systems depicted in FIG. 1 to Internet 50 may be of various types including hardwire links, optical links, satellite or other wireless communications links, wave propagation links, or any other mechanisms for communication of information. Various communication protocols may be used to facilitate communication of information via the communication links. These communication protocols may include TCP/IP, HTTP protocols, extensible markup language (XML), synchronous optical network (SONET) protocols, synchronous digital hierarchy (SDH) protocols, wireless application protocol (WAP), protocols under development by industry standard organizations, vendor-specific protocols, customized protocols, and others.

Technology developers 110 include corporations, universities and individual inventors seeking to file patent applications and receive issued patents. Patent law firms 120 include patent practitioners, such as, U.S. patent attorneys, patent agents and foreign patent practitioners and/or agents. For purposes of this application, the word “practitioner” is intended to include attorneys, agents, or any other individuals authorized to represent a client in legal cases including intellectual property cases. For example, patent practitioners may include patent attorneys, patent agents, foreign attorneys dealing with patent cases, foreign patent agents, and the like.

Service providers 130 include patent draftsman, prior art search companies, translation companies and other entities that provide services useful to the patent process as well as financial institutions and other parties that have tangential roles in the process. Prior art databases 150 include public and licensed private databases, such as online patent databases (e.g., issued U.S. patents, published European and Japanese patents, etc.) and non-patent databases. Patent offices 160 include patent offices worldwide including the USPTO, the European Patent Office (EPO), the Japanese Patent Office (JPO), the Taiwanese Patent Office, etc.

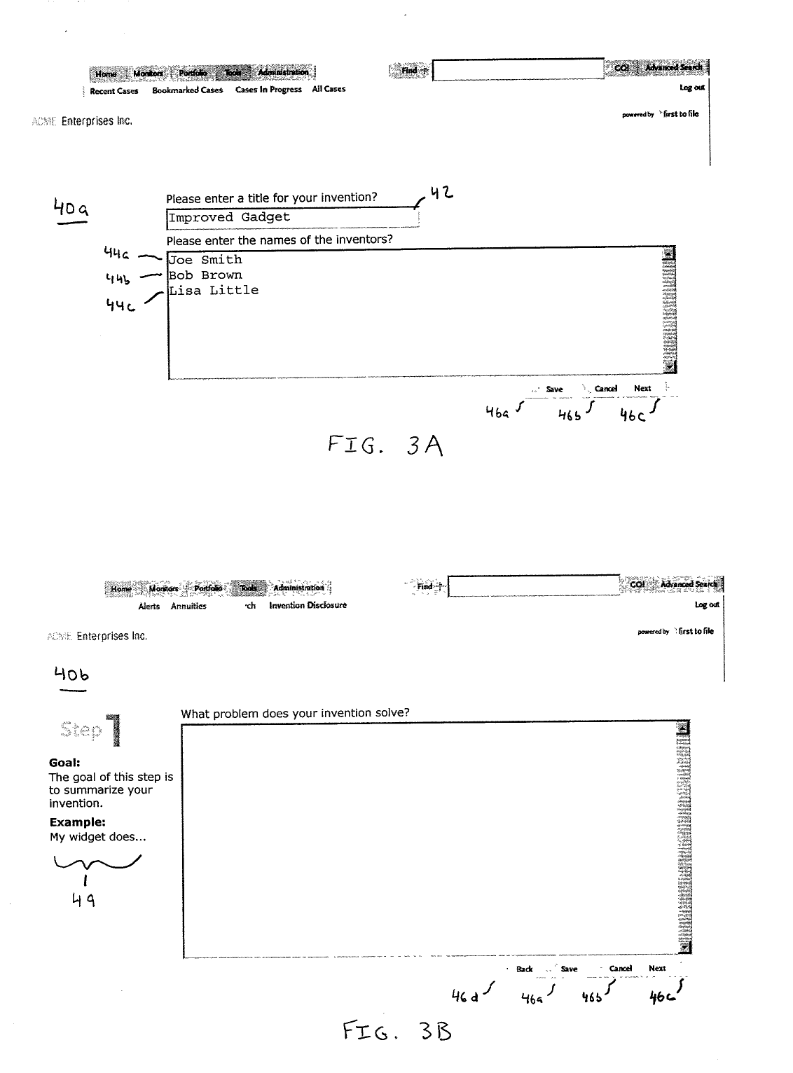

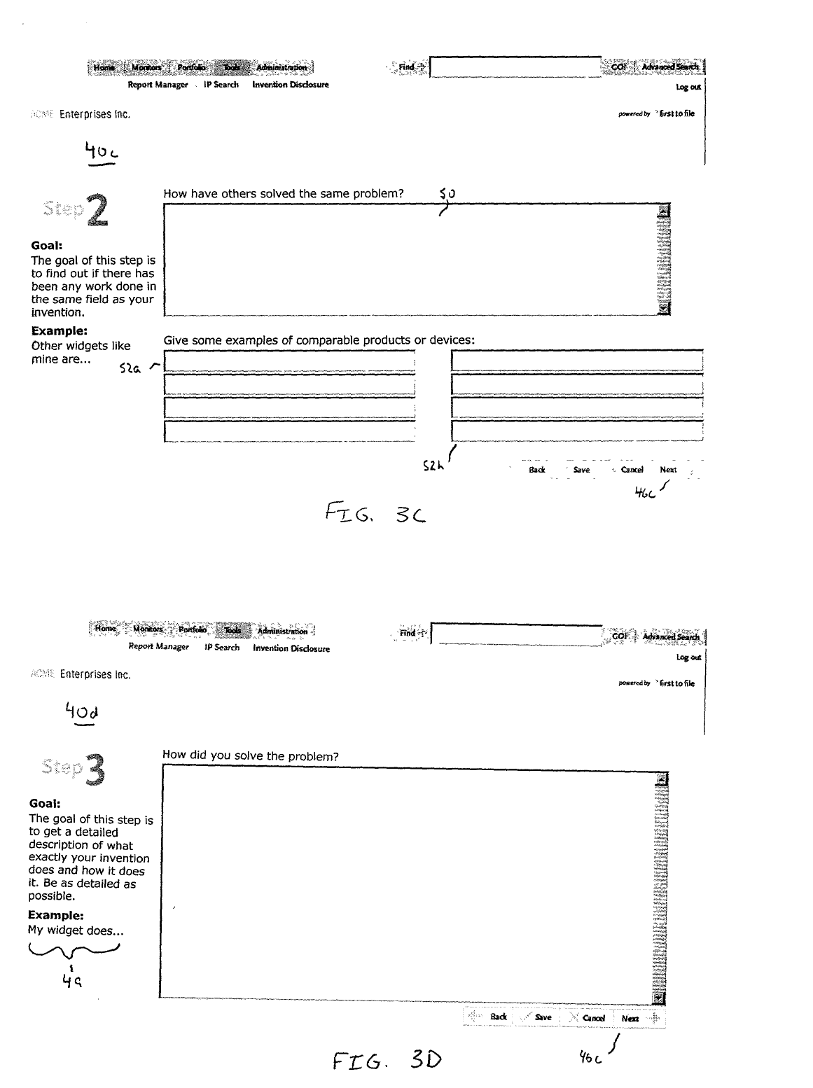

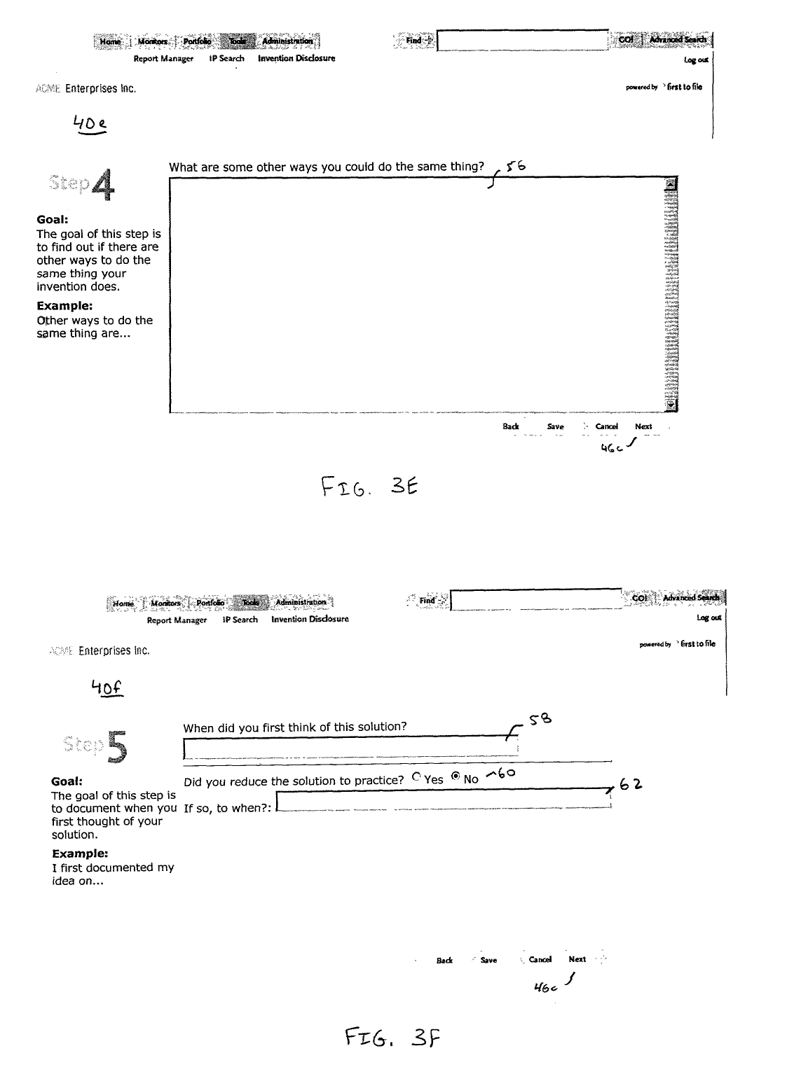

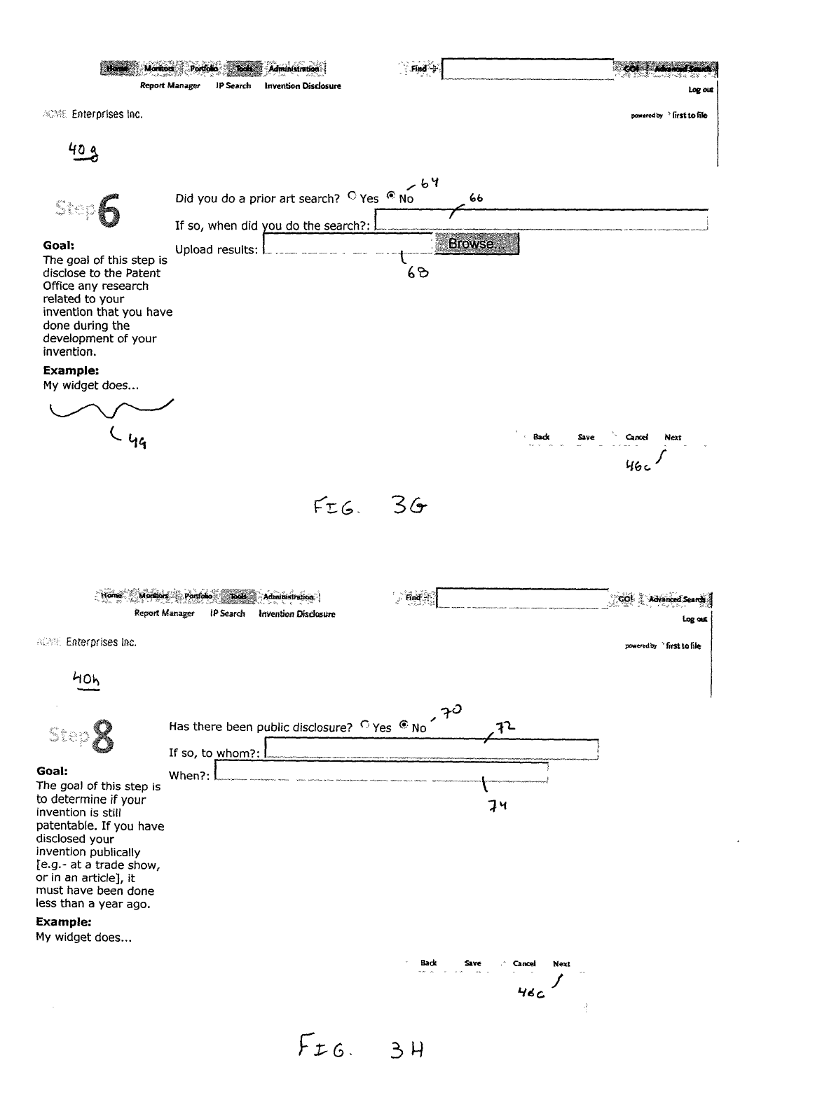

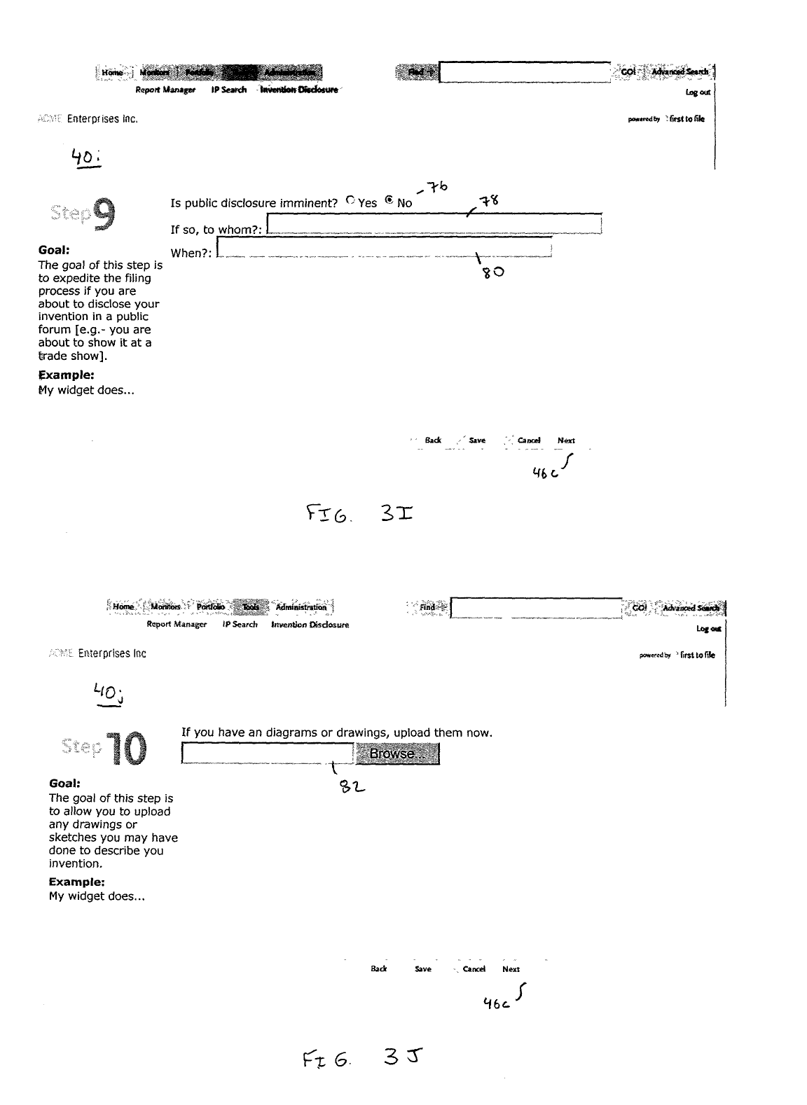

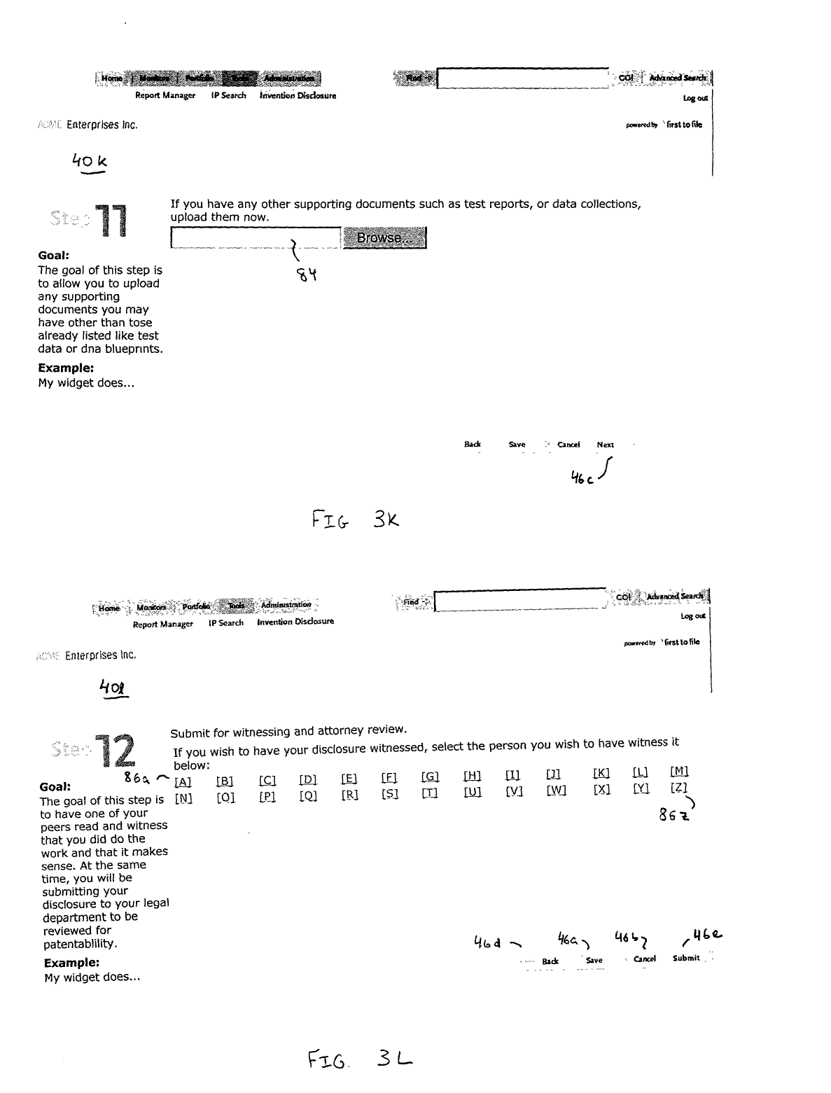

As shown in FIG. 2, IP data processing system 100 includes a Web server 101, a database 106 and paper mailroom 108. System 100 also includes an access management system 109 that provides Case Data Unit security services as described in more detail below. Web server 101 includes a server engine 102 that generates and sends graphical documents including Web pages 104 to client systems as requested and an electronic mailroom 107. In a distributed system such as that depicted in FIG. 1, computer systems that request data or services are classified as client computer systems while computer systems that provide the data or services requested by client computers are classified as server systems. Accordingly, the computer system(s) of IP data processing system 100 may be classified as server systems while computer systems of the participants may be classified as client systems. It should be apparent that a particular computer system may function both as a client system and a server system based upon whether the computer system is requesting data and/or services or receiving data and/or services. Thus, technology developers 110, patent law firms 120, service providers 130 and licensees 160 typically include one or more client systems. For example, a large corporation (technology developer) may have 150 inventors, four patent administrators and two in-house patent practitioners. Each of these individuals likely has their own computer system and can thus become a client system. Additionally, computers that are part of patent offices 140 can also be client systems in some embodiments of the invention as described below with respect to both FIGS. 2 and 3.

Each client system displays the Web pages generated by server engine 102. Each of such Web pages is uniquely identifiable by a Uniform Resource Locator (URL) and is stored in a computer-readable memory (not shown) accessible to the server engine. To view a specific document, including a Web page, a client system uses a Web browser executing on the client system to specify the URL for the document in a request (e.g., a HyperText Transfer Protocol “HTTP” request) as is known to those of skill in the art. The request is forwarded to the Web server supporting the document (server system 101 in this instance), which when it receives the request, sends the requested document to the client system. The Web browser may then display a Web page contained in the document, e.g., HTML document.

Database 106 stores all information pertaining to the patent developers' intellectual property portfolios. Patent process participants (such as the technology developer employees and outside law firm personnel) access this information as needed and only to extent that their access rights permit. The information in database 106 includes draft and completed invention disclosures; draft and completed patent application documents; other papers filed in patent offices, such as, responses to office actions, petitions, information disclosure statements, etc.; papers sent from patent offices, such as, filing receipts, office actions, signed PTO-1449 forms, etc.; messages and discussions pertaining to invention disclosures and patent applications; patent and patent application status information; prior art publications; and the like.

In one embodiment, IP data processing system 100 is a distributed network system that communicates with patent offices 140 over internet 50 through electronic mailroom 107 and through standard mail (e.g., U.S. Postal Office Express Mail) using paper mailroom 108. For such communications, system 100 sets the correspondence address to mailroom 107 or 108 so that replies to the communications can be tracked and entered into database 106 as described below.

It should be apparent that distributed system 100 depicted in FIG. 1 is merely illustrative of an embodiment incorporating the present invention and does not limit the scope of the invention recited in the claims. One of ordinary skill in the art would recognize other variations, modifications, and alternatives. For example, in alternative embodiments of the present invention, system 100 may be deployed in various other environments such as an enterprise environment, a stand alone system, and the like.

Electronic mailroom 107 is part of server 102 and includes a suite of programs that interface to the standards set by each patent office 140. For example, in order to file patent applications electronically through the USPTO the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://pto-ebc.uspto.gov/. Also, in order to track and update status information for pending patent applications, such as Examiner name, assigned art unit and class/subclass, etc., electronic mailroom 107 has the ability to interface to USPTO's Patent Application Information Retrieval (PAIR) system using appropriate digital certificates. Electronic mailroom 107 also includes other programs to interface with other patent offices.

Paper mailroom 108 includes printers, fax machines, fax servers and other appropriate equipment to carry out all the duties necessary to file patent applications and other formal papers in patent offices using standard mailing procedures. Paper mailroom 108 also includes scanners and equipment necessary to scan papers received from technology developers 2, patent practitioners 4 and patent offices 6 into computer-readable format. In some embodiments such correspondence is scanned and analyzed by optical character recognition (OCR) software to create two versions of the document: an image version and a text version created by the OCR software. The OCR software is calibrated to recognize particular fields within common Patent Office forms to capture data from those forms so that appropriate data (e.g., due dates, Examiner's name, Applicant, application no., etc.) from such papers can be parsed and entered into database 106. To this end, the fields of various Patent Office forms that are scanned by mailroom 108 are mapped to database 106 along with the document type (determined from the form recognition sequence) in order to enable the system to determine the appropriate docketing deadlines. Alternatively, or in addition to such scanning, personnel in mailroom 108 can directly enter appropriate data into database 106 using computers or data entry terminals coupled to the database through a local area network or similar network. Once scanned into computer-readable format, communication between IP data processing system 100 and technology developers 1 10 can proceed in a manner that, from the standpoint of a technology developer, seems entirely paperless.

IP data processing system 100 also provides a conduit through which potential licensees 160 may purchase technology from technology developers 110. This conduit may include both general access to the public and subscription access. For example, an individual technology developer 110(x) may decide to place selected ones of its IP assets available for license to any interested party. In this case, IP data management system lists the selected assets on appropriate Web pages generated by server engine 102 and allows public access to the assets to any client system browsing the pages. Other technology developers (e.g., prolific universities) may decide to enter arrangements with priority licensees such that these priority licensees pay a subscription fee to the university for “first look” rights at new IP assets. Under this arrangement, the priority licensees will be able to access appropriate data describing the IP assets (e.g., title, abstract, claims, inventor list) through Web pages that have restricted access rights and are thus not viewable to the general public (i.e., non-priority licensees).

Customer Set-up of IP Data Processing System 100

As mentioned above, IP data processing system 100 generates Web pages 104 that facilitate all aspects of the patent process including the generation of patent disclosures, workflow routing, generation of and prosecution of patent applications, foreign filing, annuity and maintenance fee payments, practitioner and service provider invoicing and patent licensing among others. Prior to using IP data processing system 100, however, new customers (technology developers, law firms, etc.) are generally asked to set-up an account. The set-up process allows for varying degrees of customization. On one end of the spectrum, the set-up process can be very straight forward allowing the customer to enter address and billing information and select one of several generic, predefined manners of working with IP data processing system 100. On the other end of the spectrum, the set-up process can be rather lengthy allowing a customer to highly customize IP data processing system 100 to its requirements. For example, in one set-up procedure information is entered by the customer to set-up the customer's account, record billing information, record a Patent Office deposit account number and a customer number, define the user list, define the role of each user (thereby defining various home pages), define the organizational structure and hierarchy of users, establish any interfaces with appropriate databases or applications of the customer, define the customer's workflow process as described in more detail below, define any customizable aspects of the database such as field names, forms and template wizards, database organization, and user-access rights, set any user-definable preferences, arrange for importing any user-specific content, and implement appropriate security measures such as digital certificate assignment. Set-up may also involve importing any legacy data (in supported formats) into the system using document upload process. Typically, large corporations and law firms will implement an involved set-up procedure like this while individual inventors and small companies without in-house practitioners will opt for simpler set-up procedures.

The workflow process is the process of routing documents to predetermined users, notifying the appropriate users of required tasks, periodically reminding users of task completion deadlines, and tracking time periods associated with both tasks and the time between tasks, all according to a customer-defined workflow process design. Workflow examples include the circulation of invention disclosures to a review committee for filing decisions, routing of invention disclosures to a working practitioner for drafting patent applications, circulation of draft patent applications to inventors and managers for review and comment, circulation of Patent Office forms to inventors and managers for signature, notification of practitioners of the receipt of Patent Office actions and papers, and routing of documents to service providers (e.g., informal drawings to a draftsperson for creation of formal drawings) as needed.

The workflow design is defined in the customer set-up process. In the set-up process, users are assigned roles that play a part in the workflow. Rules are established that dictate to whom documents are routed at each stage in the process, how often users should be reminded of a task, and what task is required next after each preceding task. IP data processing system 100 has a mechanism for notifying users of required tasks, and for users to notify the system that tasks are complete. The system makes available (for example, through html links to documents stored in database 106) to the appropriate users any documents necessary for performing the relevant task (e.g., a maintenance fee due date reminder task sent to an appropriate in-house practitioner at a technology developer 110(x) may include an html link to the allowed patent so the practitioner can quickly review the patent's abstract and claims). In order to track and identify bottlenecks in the workflow process, the system automatically tracks the amount of total time elapsed since the beginning of the workflow, as well as the time elapsed during the performance of each task and the time elapsed between each task. The set-up process can be rerun at a later date to allow flexibility for changing roles or tasks, eliminating tasks, changing document routing, or otherwise redefining the workflow for any document at any time by authorized users.

Once a customer (e.g., technology developer 110, patent law firm 120, etc.) has set-up IP data processing system 100 to their requirements, the system is ready to be used. The functions available to a particular client system of a particular customer depend on the role of the client system in the patent process. For example, some of the functions provided through Web pages 104 are restricted to only certain individuals and thus may not be accessible to others. Thus, Web pages 104 include different “home” pages that are the initial Web pages displayed to a client system based upon the role of the client system in the patent process. These home pages include html links to functions that have been determined to be appropriate for the particular client system as part of the set-up procedure.

As an example, the home page that is presented to the client system for an inventor working at a particular technology developer 110(x) is different from the home page that is presented to an in-house practitioner working at the same technology developer 110(x). Similarly, both of these home pages are different from the home page presented to an outside practitioner working at patent law firm 120(y) that works with and represents technology developer 110(x).

Document Management and Access

One benefit of IP data processing system 100 is the way information is assembled and managed. In some embodiments, system 100 acts as a central data repository of all information that is relevant to the patent process. Such data and information is stored by system 100 in database 106 and managed using Case Data Units, where each Case Data Unit is a collection of data and/or documents that are related to a particular case, e.g., a patent application in a particular country. In some instances a case may actually include more than one patent application, for example, where a Continued Prosecution Application (CPA) is filed in the USPTO under rule 37 C.F.R. 1.53(d). The Case Data Unit may be implemented as a data structure, a file, a database, or any other structure capable of storing data and/or documents.

In one embodiment, a Case Data Unit stores a variety of bibliographic information (referred to herein as case meta data) associated with a patent case, as well as one or more electronic documents (or references to the electronic documents) related to the patent case. Case meta data stored in the Case Data Unit may include, for example, a case title, a patent application number (serial number), a filing date, a patent number, a patent date, publication numbers and associated publication dates, a client reference number, a law firm reference number, the country the application is filed in, a list of inventors, a status indicator (e.g., filed, issued, abandoned, etc.), an assignee, information related to the assignment (e.g., an assignment recordation date and reel and frame number), a responsible practitioner, a working practitioner, priority information (e.g., serial numbers, filing dates and countries of any parent cases), etc.

The electronic documents (hereinafter referred to as “documents”) stored in a Case Data Unit may include a variety of documents of different document types. Specific examples of document types include an invention disclosure, a filed patent application, patent drawings, old versions of patent applications and drawings, other patent papers (e.g., other documents filed in the patent office including responses to office actions, information disclosure statements, petitions, etc.); forms, image files (e.g., locked documents of .pdf or a similar type of image file format corresponding to a granted patent (if a patent was granted for the case) as well as scanned copies of any office actions received, responses filed in the patent office, filing receipts, etc. issued during prosecution of the patent application); notes (e.g., practitioner notes, inventor notes, notes from other interested parties regarding the importance of the patent to a companies business, products or competitors business or products, etc.); mail (e.g., email messages or alerts) and prior art references among others. This list is for illustrative purposes only and various embodiments of the invention can include more or fewer document types as appropriate.

Each document stored in a Case Data Unit also includes appropriate document meta data that identifies the document and its history. Examples of document meta data include document ID, document type, originator, status, security profile, file format, creation date, last modified date, last modified by, physical file attributes, search field key words, completion date, witness names and dates, etc. The combination of a document, its document meta data and other information related to the document is referred to herein as a Document Entity. Further details of Document Entities are discussed below.

As stated above, access management system 109 provides security services for the patent-related information in system 100. According to an embodiment of the invention, the access management system is a gateway, either allowing or disallowing various operations to be performed upon data and/or documents associated with a case. According to one embodiment, access management system 109 either allows or disallows users to perform operations upon a Case Data Unit according to rules and permissions assigned to a user, as well as groups assignment of both users and Case Data Units. Other embodiments of the access management system further provide Case Data Unit level access information.

Access management system 109 assigns users (client systems) of system 100 and Case Data Units to one or more groups. A user assigned to a group will have access to the Case Data Units in that group and any subsets of the group. Similarly, users not assigned to the group will not have access to Case Data Units in that group. Examples of specific groups may include: Company X, Division M of Company X, Division of N of Company X, law firm Y, client team R in law firm Y, or any other logical groupings of related client systems.

In addition to user groups, system 100 assigns each user one or more roles, such as system administrator, docketing administrator, inventor, responsible practitioner, working practitioner and secretary among others. Users can be automatically assigned to groups based upon their role or a user can be manually added to a group. Further, users can be excluded from a group automatically based upon their role or can be manually excluded. While assignment to a group allows a user to access Case Data Units of the same group, it does not necessarily provide full access to all data and/or documents in Case Data Units of the group. Such access is also governed by the user's role.

To this end, each of the various roles attached to a user has associated with it a set of default permissions. A user assigned a given role is also assigned the default permissions associated with the role. Permissions provide for given tasks to be performed upon the data and/or information of a Case Data Unit. Assignable permissions include, for example, creating, modifying, and deleting cases; creating, modifying, and deleting select case meta data associated with a case; creating, modifying and deleting notes associated with a case; creating, modifying and deleting patent documents associated with a case; viewing and/or printing various documents and/or data from a case; and purging a case of unnecessary documents (e.g., rough drafts of application, unnecessary notes and the like) among other permissions. In addition to the default permissions associated with a given role, other available permissions may be assigned or deassigned to the role thus providing for customization of the permissions individual users are assigned.

Roles, in turn, have default sets of documents types assigned to them. The assignment of a given document type to a given role allows a user assigned the given role to make certain manipulations upon documents of that type. Specific examples of document types include an invention disclosure, a filed patent application, patent drawings, old versions of patent applications and drawings, other patent papers (e.g., other documents filed in the patent office including: responses to office actions, information disclosure statements, petitions, etc.); forms, image files (e.g., locked documents of .pdf or a similar type of image file format corresponding to a granted patent (if a patent was granted for the case) as well as image file format copies of any office actions received, responses filed in the patent office, filing receipts, etc. issued during prosecution of the patent application); notes (e.g., practitioner notes, inventor notes, notes from other interested parties regarding the importance of the patent to a company's business, products or competitor's business or products, etc.); mail (e.g., email messages or alerts) and prior art references among others.

Finally, access to Case Data Units can be granted or denied on an individual case level, For example, a Case Data Unit level access can be used to deny, for conflict purposes (e.g., an ethical wall), an individual client system access to a Case Data Unit sharing a common group assignment with the client system. Further details of the use of roles, permissions, groups and Case Data Units according to one embodiment of the invention are wet forth in concurrently filed U.S. Provisional Application No. 60/______ (Attorney Docket No. 020313-001710) entitled “DATA ACCESS CONTROL TECHNIQUES USING ROLES AND PERMISSIONS” and having Stephen K. Boyer, Jeffry J. Grainger and Cecily Anne Snyder as inventors. The 020313-001710 application is hereby incorporated by reference in its entirety.

As previously mentioned, in some embodiments much of the information stored in database 106 is organized into Document Entities. A Document Entity is a high-level description of a type of document that is created, manipulated, reported, tracked, etc. by IP data processing system 100. Each Document Entity is described by a collection of rules that define necessary attributes including data fields that must be complied with/populated for the given Document Entity to be considered complete, such as unique identifiers for the document and the relationship between that document and other documents in system 100. The document management function of IP data processing system 100 implements the access, edit and version control rules for all Document Entities in the system as described in more detail below.

A Document Entity is created when it is given a unique set of the attributes listed in an appropriate table in database 106. When a Document Entity is created within the context of a Case Data Unit, the Document Entity acquires some of its attributes from that Case Data Unit. For example, an amendment created for a particular patent application will automatically acquire some attributes of that patent application such as technology developer reference number, practitioner reference number, etc. Any other required Document Entity attributes must be entered by the user before the Document Entity creation step is complete.

A Document Entity may be created before or after the underlying file is created. When a client system requests the creation of a new word-processed Document Entity, IP data processing system 100 creates a new Microsoft Word (or WordPerfect) document and passes the client system into that document after all required Document Entity attributes have been acquired or entered (of course attributes can instead be entered at a later time also). Version and tracking control are provided to enable a user to track the document as it is routed through the system for review and approval. Inventors can review the document either sequentially or concurrently.

System 100 also includes an archival function that saves and locks all documents submitted to and received from patent offices so that they cannot be subsequently altered as well as an MIS log function that generates an “audit trail” that records events in a separate database table, including who, what object, what time, and what was done (read, write, edit, witness) to all documents for all customers.

The way that a Document Entity is managed will depend on the Document Entity attributes that are associated with that Document Entity at creation or thereafter. Relevant attributes include, for example: document type, status and security profile. For example, an invention disclosure (whether created by the Invention Disclosure Wizard or otherwise) can be edited only by one of the inventors for that invention, and the invention disclosure cannot be edited after it has been finalized and witnessed. As another example, draft patent application specifications (typically MS Word or WordPerfect documents) may be set up to be edited only by the originator, or may allow for an editable version to be routed to co-inventors for review and comment. All others who have authority to access the draft patent application will be able to edit new versions of the document. It should be noted that some documents sent from system 100 to patent offices 140 are actually collections of Document Entities. For example, an electronic patent application comprises a collection of Document Entities including word-processed document files (e.g., a patent specification), form-based document files (e.g., a transmittal form) and image files (e.g., figures).

When a client system requests the creation of a form-based Document Entity, IP data processing system 100 populates specific fields of the form as appropriate. For example, if the user is working on a filing for a particular U.S. patent application case and creates a transmittal form for that filing, creation of the transmittal form Document Entity within the context of that case and that filing will cause the inventor, USPTO application number, external or internal docket number, invention title, filing date, art unit, and Examiner name fields to be populated from the attributes of the case. The user also creates the underlying document file for further preparation and finalization. The system will prompt the user for specific information for unpopulated fields or confirmation (and validation) of populated fields.

IP data processing system 100 includes various forms “wizards” for assisting client systems with the completion of numerous government applications & forms. System 100 also includes software to “map” the data from the form wizards to the forms so that the users can switch from the “wizard view” to a what-you-see-is-what-you-get (“wysiwyg”) view. Additionally, some of the wysiwyg views will have direct editing capability of selected fields.

There are a variety of documents that will not be created within the IP data processing system 100. Accordingly, system 100 provides a sophisticated document upload process. The upload process provides the correct Document Entity designation. Uploaded documents fall into two major categories: (1) documents created electronically, but not within the IP data processing system 100; and (2) paper-based documents. A partial list and description of each follows.

Electronic documents that are uploaded into system 100 include patent applications, amendments, requests for reconsideration and other text-based documents prepared by client systems in MS Word or WordPerfect. These documents become Document Entities once they are in IP data processing system 100. Drawings are part of almost every patent application filed. Many drawings are prepared using some kind of graphics software. IP data processing system 100 system converts such graphic images to a common file format (such as .pdf or tiff) to allow access for all necessary participants. In addition, the original format will be retained for use with (e.g., revisions to) the original graphics tool.

As previously mentioned, system 100 also provides for paper documents to be uploaded (scanned) into database 106. The current USPTO EFS does not provide office actions and other PTO correspondence in electronic form. Rather, these mailings are made in hard copy only. Such hard copies of PTO correspondence are uploaded into IP data processing system 100 through paper mailroom 108. The current USPTO EFS also requires inventor declarations (the documents in which the inventors state that they are the actual and first inventors of the patent application's subject matter) to be signed by hand and uploaded as electronic documents for filing. As the USPTO and other patent offices being permitting the electronic communication of more and more documents between applications and the patent offices, such uploads into system 100 may no longer be necessary, of course.

Other types of paper documents that may be uploaded into system 100 include invention disclosures that are typed, handwritten or otherwise created in other than electronic form; handmade informal or informal drawings; and any correspondence, memos and notes associated with a patent application created in hard copy outside IP data processing system 100 that are associated with the corresponding patent application file and desired to be tracked in system 100.

Many documents submitted to patent offices require the signature of a person, such as the inventor, an officer of the assignee, the agent or practitioner of the inventor or assignee among others. When such documents are submitted electronically to system 100 by a customer for filing in a patent office, such documents must be signed in a manner that will be acceptable to that patent office. For example, the USPTO's electronic filing system allows documents to be submitted electronically using its ePAVE software and Entrust's system of digital certificates. Currently the USPTO will accept “electronic signatures” on certain kinds of documents that require an practitioner's signature. These electronic signatures are simply a string of characters placed by the practitioner between two forward slashes; e.g., /mickey₁₃mouse/. The USPTO currently requires copies of actual signatures, however, on inventor declarations, power of attorney and other documents signed by inventors or corporate applicants.

IP data processing system 100 permits client systems to place electronic signatures on documents patent offices allow to be signed electronically as well as on documents that can be signed electronically according to other appropriate laws or protocols. For other signed documents, the document will contain a signature field. The signer's signature can be scanned, uploaded into IP data processing system 100 and merged onto the signature field of the document. The document will not be able to be modified after it has been signed. Other forms of electronic signatures can be supported by system 100 as patent office rules are changed to allow them.

Message Boards/Alerts

One of the features of some embodiments of IP data processing system 100 is its ability to facilitate communication between all parties associated with the patent process and its ability to notify users of impending deadlines for tasks associated with individual cases. To this end, the Web pages generated by IP data processing system 100 and displayed to client systems include message and alert boards that track and displays such communications and notices. The message and alert boards also provide the ability to conduct off-line discussions pertaining to cases and Document Entities within cases. In one embodiment, these message/alert boards are available to and can be presented to all registered client systems of system 100. The content of the message/alert boards, however, varies from client system to client system as the boards show messages and alerts that are specific to each client system.

A registered client system is a client system that has run the user set-up process itself or been defined by another client system during its user set-up process. Thus, registered client systems can be contrasted to client systems that have no predefined relationship with system 100 and are just “browsing” its pages. In another embodiment, however, even such unregistered client systems are presented with message/alert boards that display general information, e.g., updates on patent law, that such unregistered client systems may be interest in.

In one embodiment, Discussion Items are a type of Document Entity that is posted and linked to a topic and to other Discussion Items as in a threaded discussion model. The Discussion Items' attributes connect Discussion Items to Case Data Units and specify access and security rules. Discussion Items are an alternative to email. Discussion Items can create a Task that sends an alert notifying a recipient that he or she has a message to respond to. The user can specify who can see or respond to a given discussion item. In one embodiment, Discussion Items are tracked and displayed in a dedicated section selectable by a client system.

Task attributes contain alert information for client systems, such as the name of the task to be performed (e.g., response due in Patent Office, new discussion item to read, etc.), the date the task is due, and the identity of the user whose responsibility it is to perform the task. There may be multiple due dates for each task, a final due date and preliminary “ping” dates reminding the user that the final due date is approaching. Tasks are displayed in the Alert Monitor. System 100 will notify client systems, for example, through the Simple Mail Transfer Protocol (SMTP), that there is an alert in the system for pick-up.

One of the more common alerts that are sent to individual client systems through the message/alert boards is docketing reminders. Docketing is the heart of managing patent information. The docketing engine of IP data processing system 100 manages the calendar of due dates for all the cases tracked by the system and allows practitioners to keep track of the meta data for the case (i.e., bibliographic information) as well as the progress of a case and the relationship between cases. The docketing software tracks meta data and date information for all cases. Meta data is case summary information including bibliographic information as described above. The software includes an engine that implement rules associated with the docketing process.

Notification of impending deadlines for cases is sent to client systems through their message/alert board. The frequency of such reminders leading up to Patent Office deadlines is determined by the client during the user set-up process. Some deadlines are defined based on dates documents are transmitted to a patent office while other deadlines are defined based on dates documents are mailed from patent offices or received by IP data processing system 100. For example, the date a patent application is filed in a first patent office triggers deadlines for filing the application in foreign patent offices. Similarly, the date an Office Action is mailed from a patent office typically triggers a due date for when a Response to that Office Action needs to be submitted.

For each such deadline or due date a new task is created that reflects the action that needs to be resolved by the deadline. When documents are received electronically by system 100, appropriate tasks are created automatically. When paper documents are received and scanned into the system tasks can either be created automatically from the scanned information that is parsed into database 106 or tasks can be created by personnel in paper mailroom 108. If created manually, only actions types that have been defined for the country in which the case has been filed in available for selection when the mailroom 108 employee enters a task type.

In most cases, based on business rules and the document type, a series of reminders and due dates are created for the task. These reminders and due dates appear in the message/alert boards of an appropriate client system as a list of outstanding actions that require response. There are some cases where an ad hoc action would be generated in association with a particular case. The reminders and due dates may be calculated based on, for example, the date of the document, the date of the application, the date of the patent, or the date of the priority application, or the earliest priority application (where there are multiple cases). Typically there is an ability to designate responsibility for completing the task in the system. In one implementation, system 100 identifies the document type from the scanned image or electronically received document as well as the Case Data Unit the document is associated with. System 100 can then automatically associate a task in response to the scanned document.

There are two types of dates typically associated with a document task. The first is a reminder (soft date), the second is an actual due date (hard date). Actual due dates can be extendable due dates (where extensions of time are available) and firm due dates (where extensions of time are not available). In one embodiment, customers are able to select an option where reminders appear on the task list only until the date of the reminder and then automatically lapse in favor of the actual due date or a later reminder. Actual due dates are removed from a client systems message/alert board by either extending the due date (manually), by indicating that task was completed (e.g., the Response was filed) or assigning the task to another client system that acknowledged and accepted the assignment of responsibility.

Further details of how system 100 can implement such docketing rules are set forth in U.S. patent application Ser. No. 09/______ (Attorney Docket No. 020313-001810) entitled “DOCKETING SYSTEM” and having Cecily Anne Snyder as inventor. The 020313-001810 application is hereby incorporated by reference in its entirety.

Functions Commonly Used by Inventor Client Systems

In addition to the message/alert boards discussed above, another function available to an inventor client system at a given technology developer 110(x) is the creation of an invention disclosure on IP data processing system 100. In one embodiment, IP data processing system 100 supports two ways of creating invention disclosures. The first is an upload of a document created outside the system using the Document Upload process described below. The second is the Invention Disclosure Wizard. When launched, the Wizard advises the inventor if there are invention disclosures in the drafting process and asks whether the inventor wishes to further revise a pending disclosure or create a new one. The Invention Disclosure Wizard walks the inventor through to process by asking one or more questions per screen and providing a space for the inventor to enter the answer. A help function is also provided to provide further explanations of individual questions. The answers to the questions become html-coded fields mapped to database 106. The system allows administrator customization of the questions asked by the Wizard and the order in which they are asked. The system also allows individual questions to be skipped and answered later in an order different from that originally presented. In one embodiment, there is a basic and expert version of the Wizard.

Once the invention disclosure is entered into IP data processing system 100, routing rules previously entered through a setup process determine what sequence of events are triggered. For example, according to one possible set of routing rules, where the inventor who fills out the invention disclosure lists several other co-inventors, the disclosure is given a unique identification number and routed to each inventor for approval as well as to an appropriate engineering manager. Once approved by each of these parties (approval indications are stored in database 106), a copy of the disclosure is archived, date-stamped and locked to prevent further changes. The disclosure can also be witnessed at this stage as described below. Approval of the invention disclosure can be made, for example, by selecting a “reviewed and approved” icon that can be displayed on the Web page(s) that present the invention disclosure to the reviewing client systems.

The completed disclosure is then forwarded to an in-house practitioner for review and, once practitioner approval is obtained, routed to a patent lawyer 120(x) assigned to prepare the non-provisional application. While documents can be routed as described above according to predetermined workflow rules, the routing list (list of recipients) can also modified to add or delete recipients as appropriate.

In one embodiment the Case Data Unit for the invention disclosure is assigned an additional group concurrent with the disclosure being assigned to a patent practitioner where the additional group is a group that also assigned to the patent practitioner. This allows the patent practitioner can access data and documents in the Case Data Unit to the extent the permissions assigned to the practitioner allow such access. As an example, prior to approving preparation of a patent application from the invention disclosure, the disclosure's Case Data Unit may be assigned to one group: Technology Developer X, a group to which the in-house practitioner and each inventor are also assigned. Because patent practitioner 120[x] is an outside practitioner, he or she is not assigned to the Technology Developer X group, but may instead be assigned to a group such as Attorney X. Once approval for preparation of a patent application for the invention disclosure is obtained, the Case Data Unit becomes assigned to two groups, Technology Developer X and Attorney X. In other embodiments, a client system from Technology Developer X may define, during the customer set up process, that all Case Data Units for that technology developer be assigned to Attorney X upon creation rather than upon receipt of approval for preparation of a patent application. Such a rule may be useful, for example, when the technology developer seeks input from the patent practitioner on whether or not a patent application should be prepared for invention disclosures.

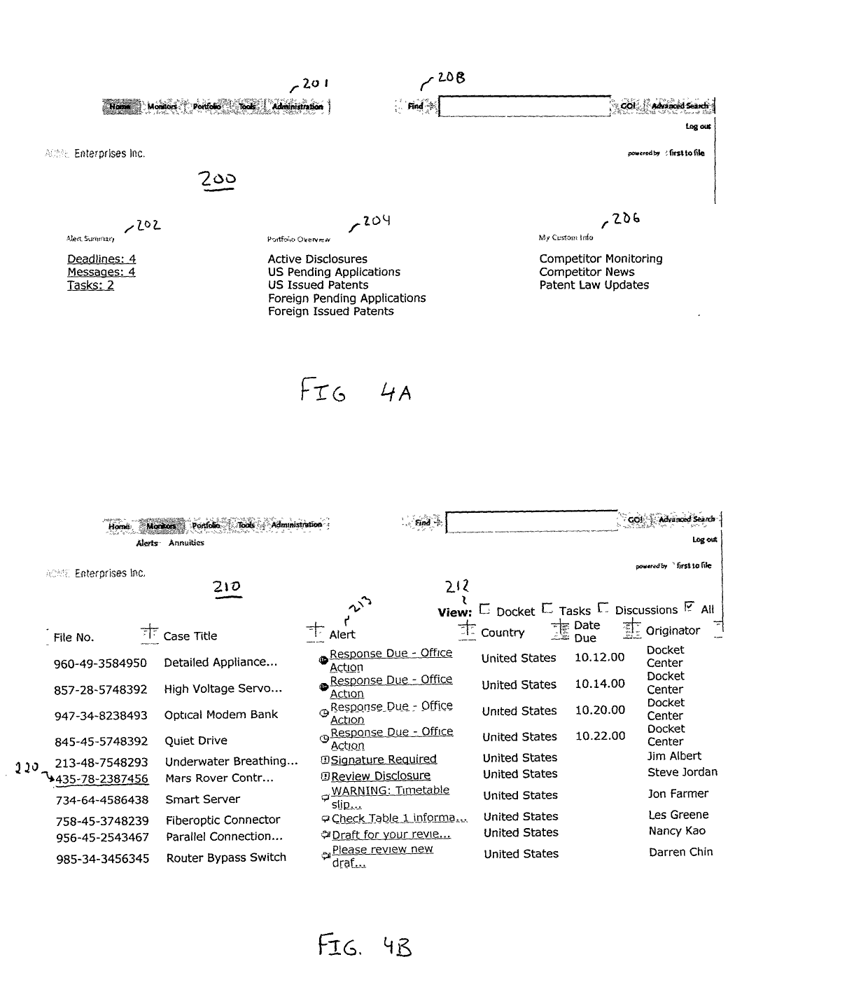

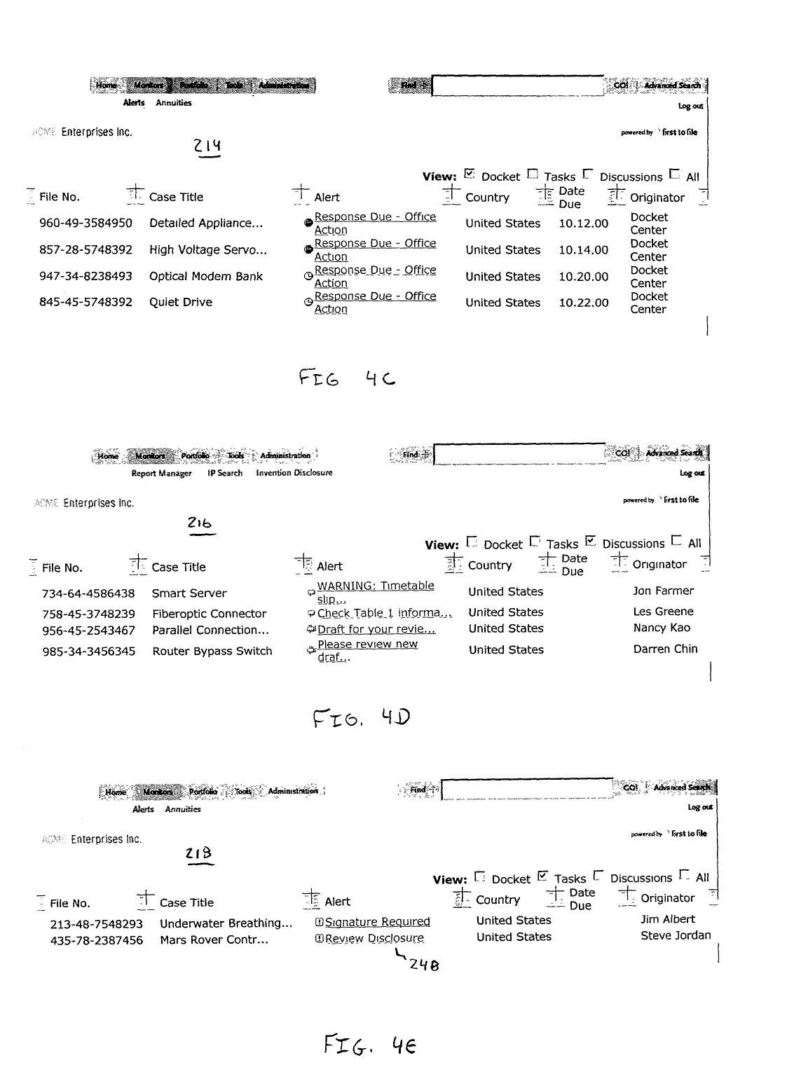

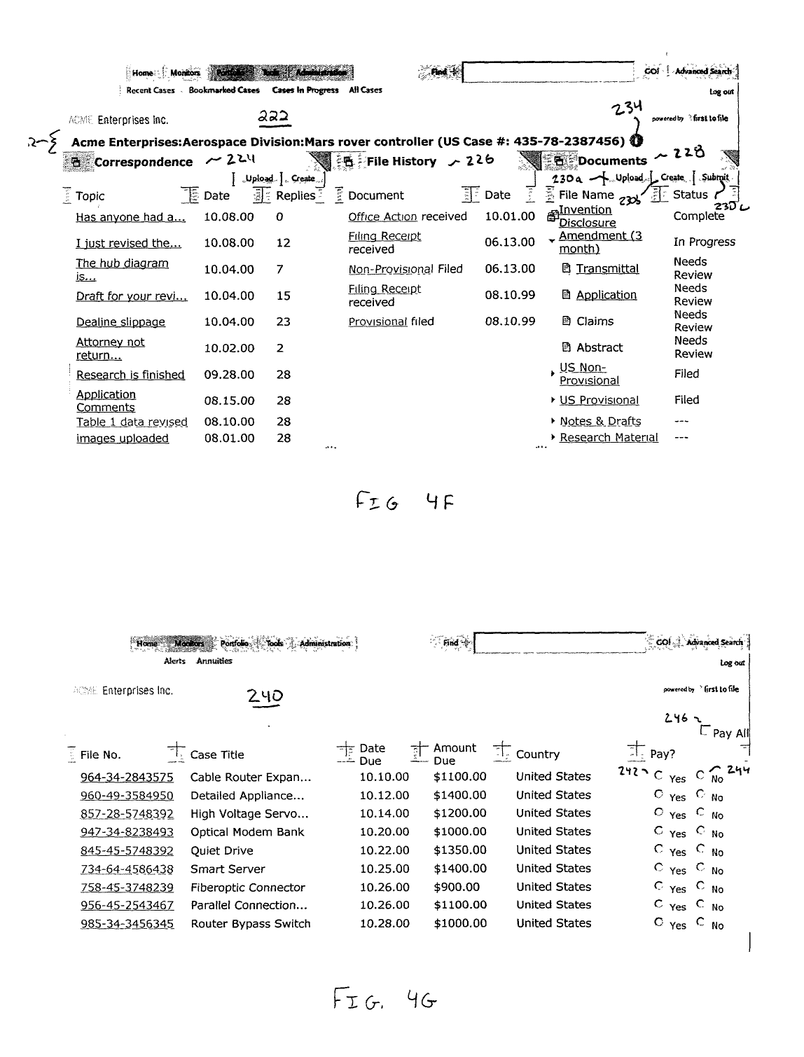

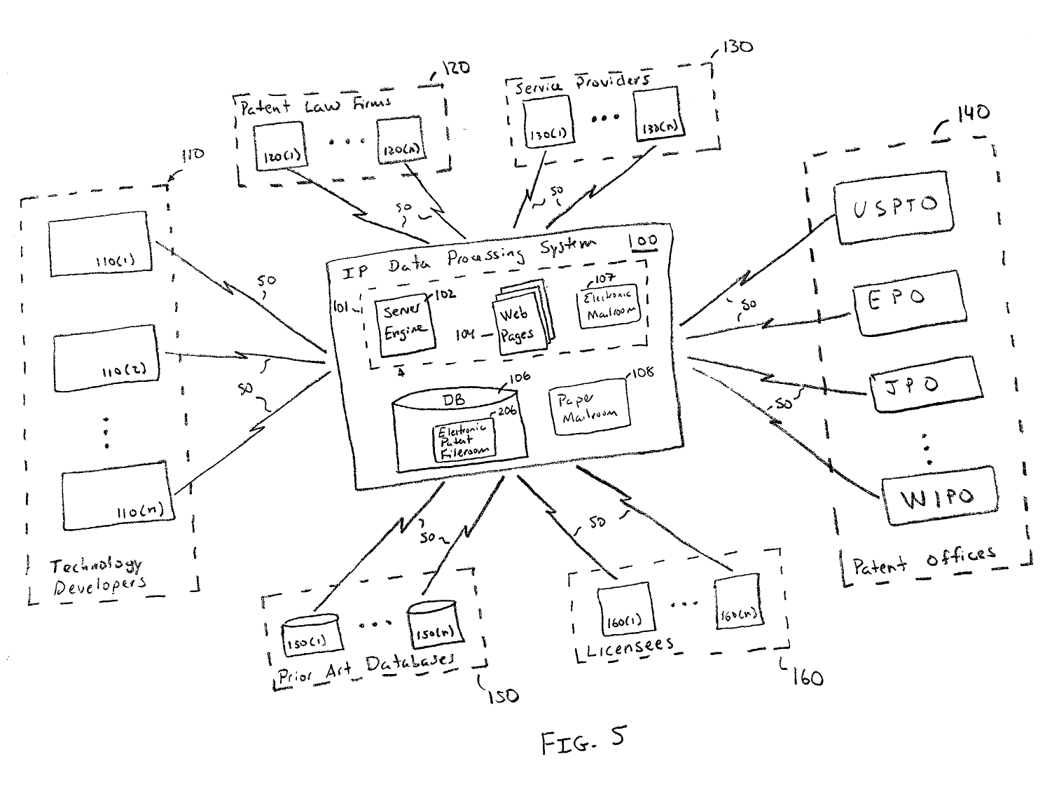

In one embodiment, “routing” of documents is performed by generating an alert message in the recipient's (e.g., patent practitioner's) alert monitor. The alert includes a link to a message that can be created by the client system that initiated the routing process (e.g., a message indicating the recipient has been tasked with preparing a patent application for the invention disclosure). Selecting the link displays the message as well as links to any other documents that are routed with the disclosure. An example of a selectable requesting a recipient to review an invention disclosure is shown in FIG. 4E as link 248. FIG. 6 is an example of a Web page 250 that may be displayed when a link such as link 248 is selected. Web page 250 includes a message 252 and several attachments. The attachments shown in FIG. 6 include an invention disclosure 254, a prior art list 256 (already compiled into a PTO 1449 form), a patent 258 that is of particular interest to the recipients of the routed invention disclosure message and another attachment 260 describing research the inventor has done related to this invention disclosure. In one embodiment the attachments 254, 256, 258 and 260 are links to underlying documents stored in database 106. Also, in some embodiments, Web page 252 allows the recipient to indicate a status of his or her review, for example, by selecting “approved”, “edited” as well as other appropriate status icons to route the disclosure to a next recipient. In still other embodiments, such status responses can be made through the alert monitor screen.

Referring back to the invention disclosure creation process, in one embodiment, there are two possible outputs from the Invention Disclosure Wizard. First is the invention disclosure itself, which shows the questions, the answers and any data entered automatically by IP data processing system 100 (such as document creation date and document completion date). The second is an automatically generated patent application specification (either a provisional application or a regular non-provisional application as defined by the routing rules). In some embodiments, technology developers may set up workflow rules that convert all invention disclosures to provisional applications upon approval of patent application filings for such invention disclosures. In still other embodiments, workflow rules may allow an in-house patent practitioner to select whether or not an automatic provisional application will be prepared for an approved case.

As part of the invention disclosure creation process, IP data processing system 100 provides a “witnessing” function that can be used under current U.S. patent laws to establish an invention date (date the invention was reduced to practice) prior to the filing date of the patent application subsequently prepared from the invention disclosure. In one embodiment, IP data processing system 100 provides two ways of witnessing the invention disclosure. The first permits a witness to read the document then “sign” it using the signature process described below and enter a date for the signature. The second method allows system 100 in itself to be the “witness.” System 100 can “witness” the invention disclosure document by automatically providing a reliable document creation date and by preventing any changes to the date or the document content. System 100 logs, through the MIS logging function (described below), that an employee has read the invention disclosure. Any changes made to the invention disclosure after the witnessing and before submission of the disclosure will invalidate the witnessing. Re-witnessing will be required.

When submitting a disclosure, filing an application, or receiving an issued patent, many companies have programs that provide incentives to stimulate inventors' participation in the patent process. IP data processing system 100 provides a mechanism that communicates to an external system the time and date such events occur. Specifically, IP data processing system 100 tracks relevant invention disclosure, patent application and patent issuance information and passes this information to the corporate accounting department or other department charged with dispensing inventor incentive awards as defined in the user set-up. When such awards are paid, the accounting department may enter a paid status for the award into database 106. IP data processing system 100 also generates Web pages that allow individual inventors to check on the status of their invention disclosures/patent applications along with the status of payment for any invention disclosure awards associated with the same. Similarly, a technology developer may post information related to its inventor incentive program on a Web page that can be accessed by all inventors associated with the technology developer from its home page. Such information may include, for example, the dollar amount of awards paid out under the program to date, the number of awards paid to individual inventors, etc. This allows all inventors at the technology developer to “see” who are the most prolific inventors at the technology developer and fosters a friendly but competitive environment to be the top inventor thereby further encouraging submission of invention ideas into system 100.

Another function presented to the inventor is internal and external searching through various databases 150 including technical reference and patent databases. IP data management system 150 allows client systems to search through databases 150 using a common search engine and single search interface. This greatly simplifies the search process so that client systems are not required to learn different search engines for each different database that is searched. Additionally, system 150 allows a client system to define a search and then select which databases are to be searched. The selection mechanism allows for all databases to be searched, just patent databases, just technical journal databases and almost any other combination.

If the search function is executed during creation of an Invention Disclosure or after an Invention Disclosure has already been submitted, the process allows the client system to associate results from the searches with the reference number for the Invention Disclosure. When references are associated in this manner for a case that already has been submitted to a patent practitioner for preparation (or a case in which a patent application has already been prepared and filed), a message alert is automatically created and sent to the appropriate practitioner client system. This enables the practitioner client system to either review the references prior to or during preparation of the patent application or, if an application has already been submitted, review the references to decide whether an Information Disclosure Statement should be prepared and filed for the case. One way of allowing an inventor client system to associate references with a particular Invention Disclosure is to save the search results as a file, upload the file and associate the file with the Invention Disclosure.

Another method of associating specific references with an Invention Disclosure is through a reference shopping cart. In one embodiment, such a reference shopping cart is displayed on the search Web page. The Web page then allows the client system to select a bibliographical entry (e.g., the title) for an individual reference and drag the entry to the reference shopping cart. If the client system has already associated the searching function with a particular Invention Disclosure the reference becomes associated with that disclosure automatically. If no particular Invention Disclosure was identified as the subject of the search, however, the client system is prompted to identify an Invention Disclosure once a reference has been added to the shopping cart. In another embodiment, references are added to the shopping cart by selecting the reference and then selecting an icon such as “add to reference shopping cart.” System 100 includes a software module that parses the necessary data from the prior art database 150 into fields appropriate for an IDS. When an practitioner client system selects to create an IDS from such data, system 100 populates all appropriate fields of the IDS with the parsed data. In still another method, where the IDS is sent electronically to a patent office, system 100 saves each reference identified by the inventor client system in database 106 and creates an IDS form (e.g., a PTO Form 1449) that includes html links to the saved document in database 106. The html links may be populated, for example, in a field that uniquely identifies each reference (e.g., the patent number for a patent document). When a Patent Examiner then views the document electronically, the Examiner can select the html link to see the reference on his or her computer thereby eliminating the need to send and/or print paper copies of the references.

Example of the Invention Disclosure Wizard

FIGS. 3A-3L are exemplary Web pages 104 generated by server engine 102 as part of the Invention Disclosure Wizard according to one embodiment of the present invention. These Web pages are presented to an inventor client system when the inventor client system activates the Invention Disclosure Wizard by selecting an icon (e.g., an html link) from a Web page presented to the client system, such as the inventor client system's Home page (not shown).

Once activated, the Invention Disclosure Wizard presents a Web page, such as page 40a shown in FIG. 3A, to the client system to prompt the client system to enter a title for the invention (field 42) and a list of inventors (fields 44a, 44b and 44c). The information entered in fields 42 and 44, as well as the information entered in the remaining fields of these exemplary Web pages, are mapped into appropriate tables in database 106. The fields can subsequently be altered up until the point where they are locked by another client system that has appropriate access, for example, one of the co-inventors. Locking of the fields occurs according to rules defined during user set-up, for example, once the invention disclosure is witnessed.

Web page 40a also includes html links 46a, 46b and 46c that allow the client system to Save the Invention Disclosure, Stop the Invention Disclosure Wizard without saving the newly entered information (a Cancel function) and proceed to the Next step, respectively. Upon selecting html link 46c (the Next function), a Web page 40b shown in FIG. 3B is presented to the client system. Web page 40b allows the inventor to enter text describing the problem solved by the invention in a field 48. Text 49 helps further explain to the client system how to complete field 48. Text 49 may also include an html link that provides further help and examples to the client system.

As shown in FIG. 3B, Web page 40b also includes html links to Save, Cancel and proceed to the Next step (i.e., instruct server 102 to display the next Web page to the client system). For convenience, each of these links is labeled with a reference number identical to the reference number used in Web page 40a. It is to be understood that selecting the Next function 46c from Web page 40b takes the client system to a different Web page than selecting the Next function from Web page 40a. Like reference numbers will be used for similar functions throughout each of Web pages 40a-401 presented in FIGS. 3A-3L. Also as shown in FIG. 3B, Web page 40b includes a link 46d that takes the inventor back to the previously shown Web page so that the inventor can review and/or edit information previously entered. This function also allows an inventor to easily skip a certain field presented on one Web page and return to that field at a later time to complete the invention disclosure.

Upon selecting Next page link 46c from Web page 40b, a Web page 40c is displayed as shown in FIG. 3C. Web page 40c allows the inventor to enter information related to how the problem was solved by others (field 50) as well information related to specific examples of comparable products or devices (fields 52a to 52h). Web page 40d shown in FIG. 3D allows the inventor to enter information related to how he or she solves the problem the invention overcomes (field 54), and Web page 40e (FIG. 3E) allows the inventor to enter information related to different embodiments of the invention—other ways to solve the problem (field 56). While not shown in FIG. 3D, text 49 may include information related to patent law concepts such as enablement and best mode. This text instructs the inventor to enter information related to best mode and enablement issues and may include additional html links further explaining these concepts.

Web page 40f in FIG. 3F instructs the inventor to enter information related to the date the invention was first conceived (field 58) as well as information related to if and when it was reduced to practice (fields 60 and 62). While not shown, text 49 may include html links that further explain the importance of this information as well as further explain the concept of reduction to practice. Web page 40g (FIG. 3G) asks the inventor if he or she performed any sort of prior art search (field 64) and, if so, allows the inventor to enter dates related to the search (field 66) and upload the search results (field 68—if they are stored as a computer file. Alternatively, the inventor could type in the results of the prior art search by selecting an appropriate option presented through text 49 but not shown in FIG. 3G.

Web pages 40h and 40i (FIGS. 3H and 3I) ask questions related to whether the invention has been disclosed to the public or if there are any known plans for disclosure (fields 70-80). Text 49 on these pages may include html links defining what “disclosure” means within the context of the patent laws of various countries. Web page 40j (FIG. 3J) then allows the inventor to upload any drawings or figures (e.g., from a drawing program like ViSiO™ or ones that were hand drawn and scanned into .pdf format) in field 82 while Web page 40k (FIG. 3K) allows the inventor to upload additional information that is useful in explaining the invention in field 84. Such information may include a presentation to be given by the inventors, test data, etc.

Finally, Web page 401 (FIG. 3L) allows the inventor to forward the invention disclosure for witnessing by another inventor or co-worker. In FIG. 3L, fields 86a-86z represent different individuals (client systems) that are able to witness the invention. Typically these individuals are employees of the same technology developer so that their viewing of the invention disclosure does not constitute a “public disclosure” within the meaning of the patent laws. While shown in FIG. 3L as html links [A] through [Z], fields 86a-86z will more likely identify the name of the possible witnesses to enable the inventor to quickly choose an appropriate individual. Also shown on Web page 31 is html link 46ethat allows the inventor to Submit the invention alert. Selecting this option tells IP data processing system 100 that the alert is completed and should be routed to the next client system as previously determined by the routing rules defined during the user set-up process.

Functions Commonly Used by Practitioner and/or Patent Administrator Client Systems

The home page for practitioners (both in-house and outside counsel) and patent administrators allows quick access to reporting capabilities that enable “big picture” views of company's (or client's) IP assets. The home page also includes a message/alert board similar to that described above that tracks and presents messages and alerts to individual client systems. Practitioners and administrators can navigate through documents, cases and case families using multiple groupings. Example groupings include: company, division (multiple levels), business units, products, projects, classification and technology. The groupings can be customized through the user set-up process.

Data from database 106 can be ported into numerous reports that can be generated, displayed and printed by IP data processing system 100. For reporting of data about patent portfolios, invention disclosures, practitioner workload, cost, performance, workflow history, Patent Office delay, inventor incentives, and other information, system 100 provides the capability for displaying such data in tabular or list form, or in graphical form. A number of different graph style options may be used, such as pie charts, bar graphs, Gantt charts, etc., with various line types, colors, fonts, and other stylistic options.

FIG. 4A is an example of a Web page 200 generated by server 102 as the home page for an in-house practitioner client system according to one embodiment of the present invention. As shown in FIG. 4A, Web page 200 includes five primary components: a navigation menu 201; an alert summary section 202, a portfolio overview section 204, a custom information section 206 and a search function 208. Web page 200 is for example purposes only. Other home pages may include different components, provide access to different functions or features and/or display the components in a different layout.

Navigation menu 201 indicates to the user of the client system what function the client system is accessing in the menu system of various functions provided to that client system by IP data processing system 100. For example, on Web page 200, the Home icon in menu system 201 is in bold indicating the client system is viewing the Home page. Menu 201 also allows the client system to select the icons shown in the menu system to go directly to the associated function. Five separate icons are included in menu section 201 of Web page 200: Home, Monitors, Portfolio, Tools and Administration. Alert summary section 202 indicates what type of alerts are active on the client system as well as how many of each type. As evident from page 200, this particular client system includes four alerts with deadlines (e.g., docket items), four message alerts (e.g., communications between practitioners or from an inventor) and two tasks (e.g., non-docket To-Do items, such as review and approve an initial draft application prepared by an outside practitioner).

Portfolio overview section 204 provides quick access to some of the various reporting capabilities of IP data processing system 100, and custom information section 206 provides access to functions such as patent watches, industry news and patent law updates. Search section 208 is a search engine that allows the client system to perform full text searches on all information stored in database 106. Some typical information searched includes inventor name, case reference number, patent serial number and the like. The search engine provides both basic and advanced searching capabilities including Boolean and natural language searches among others. The search engine only returns results for information the particular client system has rights to view.

In order to view the current messages and alerts the client system is tracking, the client system can select one of the entries in alert summary section 202 or can select the monitor icon from menu section 201. FIG. 4B shows a Web page 210 where the client system chose to view its alerts through menu section 201. Web page 210 shows all the current alerts 213 for the client system including docket alerts, tasks and discussion alerts. A field 212 allows the client system to filter alerts 213 by alert type. FIG. 4C shows a Web page 214 generated when field 212 is selected to display only docket alerts; FIG. 4D shows a Web page 216 generated when field 212 is selected to display only tasks; and FIG. 4E shows a Web page 218 generated when field 212 is selected to display only discussion alerts.

In each of Web pages 210, 214, 216 and 218, individual alerts are shown with respect to the case reference number (file number), title, due date (if one exists) and originator of the alert. Further details of each alert (e.g., the text of a discussion alert message) can be viewed by selecting the html link underlying the selected alert in alert section 213. Additionally, all documents associated with a particular case (i.e., all data and documents in the Case Data Unit for the particular case) are accessible by selecting the reference number or title of the case (although not shown in the figures, each of these entries is an html link to underlying information). For example, selecting file 220 having a File No. 435-78-2387456 and entitled “Mars Rover Controller” (hereinafter referred to as the “Mars Rover” file) from Web page 210 results in display of a Web page 222 as shown in FIG. 4F.

Web page 222 emulates the look and feel of an actual trifold paper file. This “trifold” view of a specific case is typically accessible from any menu option where data associated with specific cases is displayed including the portfolio view, search engine 208 and others. There are four primary sections on Web page 222: correspondence section 224, file history section 226, document section 228 and case summary section 232. Correspondence section 224 may include multiple folders with each folder including specific types of information, for example, one folder may include a list of all correspondence between a law firm and in-house practitioners, patent administrators and inventors for the selected patent matter while another folder may include practitioner notes. Individual pieces of correspondence, for example email messages, contained in a folder or displayed directly in section 224 may be accessed by selecting an html link that leads to the underlying correspondence document. Thus, to view an individual piece of correspondence in section 224, the user of the client system simply selects the link associated with the desired correspondence document. Correspondence documents can be email messages, word processing documents, scanned image files as well as other types of documents.

Similarly, each of the documents shown in file history section 226 and document section 228 are also html links to underlying documents. File history section 224 lists all the official papers that have been sent to and received from the patent office. These documents are stored in an image format (e.g., .pdf, .bmp or .tiff file formats). The image format preserves the actual look of any paper documents that were either transmitted to a patent office in paper format or received from a patent office in paper format. The image format also prevents the documents from being accidentally modified or edited in most instances. In some embodiments, the patent documents in file history section 226 are also locked so that they cannot be edited or deleted by most users.

Document section 228 lists files associated with the selected patent application that were created by the applicant, the applicant's attorney or similar party. These patent files include documents such as invention disclosures that are not filed in a patent office as well as patent application, responses to office actions and other documents that either were filed or are going to be filed in a patent office. Many of the patent files listed in document section 228 are stored in a format in which they are accessible, and editable if they are not locked, to the application program from which they were created or with which they are associated. Typically these files are stored in a format native to the associated application. For example, an invention disclosure, a patent application and a response to an office action that were all created by MS Word™ 2000 may all be stored in a .doc file. In other embodiments, however, it is possible to store these files in other formats such as text files (.txt) or compressed files (.zip) that are readily convertible to native file formats by the application program itself. As with other sections, documents in section 228 may be organized in file folders. Because there is one centralized file for the technology developer, law firm and other participants, such as licensees, each of these entities accessing the centralized file may create a “private” folder in either or both correspondence section 224 and document section 228 of the trifold for maintaining internal correspondence that is not intended to be shared among other participants in the process.

Finally, case summary section 232 includes summary information about the particular patent application such as one or more of the invention's title, the list of inventors, the application filing date, the application number, list of countries the application was filed in, etc. In the embodiment illustrated in FIG. 4F, a small subset of this information is displayed directly in section 232 (e.g., the title) and more detailed summary information can be accessed by selecting an information icon 234. Further details on this and other appropriate graphical user interfaces is presented in U.S. patent application Ser. No. 09/919,764, filed on Jul. 31, 2001 (Attorney Docket No. 020313-001100US), entitled “User Interface for Managing Intellectual Property,” listing Jeffry J. Grainger as inventor, which is hereby incorporated by reference in its entirety.

Also shown in FIG. 4F are upload, create and submit icons 230a, 230b and 230c. Selecting upload icon 230a allows a client system to upload a document that was not originally created through IP data processing system 100 into the system. Create icon 230b, on the other hand, allows the client system to initiate creation of a new document, such as a new patent application from an already filed Invention Disclosure or a new Amendment after receiving an Office Action. When create icon 230b is selected, all fields that can be populated with data already in database 106 are so populated.

Submit icon 230c allows the client system to submit a patent document to a patent office using either electronic mailroom 107 or paper mailroom 108. First, system 100 analyzes the patent document to determine that it is complete and ready to be submitted to a patent office. For example, if the document is a U.S. patent application, system 100 checks to ensure that the application includes a complete Specification (Background of the Invention, Summary of the Invention, Detailed Description and Abstract sections, e.g., for a U.S. filing), at least one claim, drawings or figures and formal paperwork (e.g., signed Oath or Declaration, Power of Attorney, Assignment form, etc.). If the application is not complete, system 100 generates a message that displays the missing information, a statement about whether or not the missing information is critical and a statement as to the possible ramifications of submitting the document in its current incomplete state. In such a case, the message also asks the client system if it wants to continue to proceed with submission of the document.

Assuming the document is to be filed, system 100 next determines which option for submitting the patent document is available based on the document to be submitted and the patent office 140 to which it is being submitted. If such a determination indicates that only one mailing option is available, the procedures for that mailing option are initiated. If system 100 determines that either electronic or paper-based filing methods can be used, system 100 prompts the user for a preference. In other embodiments, user preference for such situations are defined in the user set-up process causing system 100 to default to such predefined preferences.

If the patent document (e.g., a patent application) is to be submitted electronically, system 100 forwards the patent document to a patent office system 140 over internet 50 using a protocol previously determined by the patent office system to be acceptable for filing such documents. Generally such a protocol includes the patent office system generating a confirmation of receipt after successfully receiving the application. When the patent document is a new patent application the confirmation of receipt may include, for example, information denoting the filing date and serial number (or application number) assigned to the application.

When IP data processing system 100 receives this confirmation of receipt, it automatically enters the assigned filing date of the application into database 106 along with other identification information such as the application's application number or serial number. System 100 also saves a copy of the application as filed for archival purposes. Preferably, this entire process occurs in real time while the client system is viewing the document submission Web page. In this manner, a single action by the client (e.g., clicking on a “submit patent application” icon) both files the patent application and enters docketing information into database 106 that can be subsequently used to create future reminder messages to maintain or pursue protection for the ideas and concepts disclosed in the patent application. These reminder messages can then later be generated by system 100 and transmitted to appropriate client systems as described above.

Some embodiments of the invention provide a mechanism for automatically routing a completed draft patent application to one or more inventors and/or to an in-house patent practitioner for approval prior to the above patent application submission process. Such a document routing process may be defined on a technology developer by technology developer basis (or even on a division by division or other basis) during the set-up process of system 100. According to one specific example, a specific technology developer may set up routing rules where a draft application completed by a patent practitioner is routed to individual inventors for comments and/or changes. After the application has been approved by all inventors, it is then routed, in this example, to an in-house practitioner for final review and approval. Upon receiving approval from the in-house practitioner client system, the application is ready to be filed as discussed above. In some embodiments, such “routing” of documents is accomplished by sending alert messages to the route client system indicating that the draft patent application is ready to be reviewed. The alert message may include a link that allows the client system to directly view and access the draft patent application as well as other documents as discussed above with respect to routing invention disclosures.

A reviewing client system, for example, an inventor, can then edit the application directly or create a reply message to the practitioner setting forth comments, if any, to address in a subsequent draft. If a reviewing client system edits and application, system 100 tracks such edits thereby enabling the original author of the document (e.g., the patent practitioner) to readily review the edits and accept or deny the edits. A reviewing client system can also indicate approval of the draft for filing or for routing to the next predefined approval stage. Such approval can be given by selecting an appropriate link such as “approve draft application” or “approve draft application as edited.” In some embodiments, anytime edits are made to a draft application during the above process (e.g., if the patent practitioner client system accepts proposed edits from an inventor client system), a new version of the application is created and the old version is locked and saved for archival purposes.

Another feature provided by some embodiments of IP data processing system 100 includes paying annuity and maintenance fees. Messages for annuity/maintenance fee payments are sent by system 100 to specific client systems as defined by a customer during the user set-up process. For example, one customer may route all annuity/maintenance fee payment requests to an in-house patent practitioner for initial consideration. These requests will appear on the client system for the in-house patent practitioner as a docket alert entitled “annuity payment due” or “maintenance fee payment due.” The timing of the request (e.g., how many weeks before the payment is due) as well as the frequency of such requests (the number of reminders) are also determined during the customer set-up process. When the client system selects a specific annuity or maintenance fee payment alert from alert list, a pop-up window appears asking if the client system wants to pay the fee or not. The window identifies the file by reference number and title, notes the amount due for the payment as well as the payment date and includes check boxes for “yes—pay the fee now” or “no—do not pay the fee, allow the case to go abandoned.” An additional selection box allows the client system to cancel the process and decide whether or not to pay the fee later.

One benefit of the maintenance fee/annuity fee payment feature of the present invention is that if the client system wishes to look at data for the case at hand (e.g., the case Abstract, the current claims, the inventors, the business group, etc.), the client system simply selects the title or reference number associated with the case to get to this and other underlying data. Thus, the client system has direct and immediate access to all the documents that are useful to facilitate a decision for paying the fee. This is true whether the client system tasked with annuity/maintenance fee payment is the inventor, an in-house practitioner, a patent administrator or an outside practitioner or patent agent. Additionally, if the client system would like to ask for an opinion from another (e.g., an outside practitioner) regarding whether or not a specific annuity or maintenance should be paid, the client system can create an Alert that is sent to another appropriate client system (the outside practitioner in this example). The created Alert will appear in the outside practitioner's alert list and the outside practitioner will have access to all the same information (abstract, claims, etc.) the in-house practitioner could view. The outside practitioner can then respond to the alert with his or her recommendation as to whether or not to pay the fee.

Another option for annuity fee payment is presented to client systems by selecting the “Annuities” menu icon under the “Monitor” menu icon. FIG. 4G shows an exemplary Web page 240 that can be used for annuity and maintenance fee payment in this manner. Web page 240 presents to the client system a list of all annuity and maintenance fee payments that are due within a certain period (e.g., one month) as defined during user set-up. This feature is useful if a particular customer has many patent files and prefers to make annuities payment decisions in a sort of batch process, for example, once a month. As shown in FIG. 4G, Web page 240 simultaneously displays multiple cases for which annuity or maintenance fee payments are due and presents option “Pay” 242. “Don't Pay” 244 for each case as well as an option “Pay All” 246 to expedite the process for customers that regularly pay all such fees.

IP data processing system 100 retains a history of annuity and maintenance fee payment instructions. If the instruction is to pay an annuity, a payment is submitted to the Patent Office pursuant to the Payment Process described below along with information identifying the annuity being paid. Finally, there is the confirmation of payment of annuity. A payment receipt will be sent to IP data processing system 100 from the Patent Office, and the receipt will become a Document Entity within system 100 associated with the appropriate case. These receipts can be viewed by client system with appropriate rights just as other documents associated with the case and the receipts can be compared versus payment instructions as a final accounting measure to ensure payments were properly received. System 100 can also be set up to track such receipts, and if the receipts are not received within a time period specified during user set-up, send an alert to the appropriate client system of the technology developer indicating that a problem with the annuity payment may have occurred.

Further details on the payment of annuity and maintenance fees according to various embodiments of system 100 is presented in concurrently filed U.S. patent application Ser. No. 09/______ , (Attorney Docket No. 020313-004100US), entitled “COMPUTER-IMPLEMENTED METHOD OF PAYING INTELLECTUAL PROPERTY ANNUITY AND MAINTENANCE FEES” listing Jeffry J. Grainger as inventor, which is hereby incorporated by reference in its entirety.

Other Features of IP Data Processing System 100

IP data processing system provides a number of other functions that will be useful to client systems of technology developers 110, law firms 120 and other users of the system. One of these features is early publication of Invention Disclosures submitted to or created in system 100. The early publication function of system 100 allows a client system to select an invention disclosure to proceed to publication at any time during or even before the patent process. A client system may chose such an early publication tactic to expedite licensing possibilities or for defensive publication purposes among other reasons. Like the application preparation process, the publication process gives the user the option of exporting the invention disclosure text to a pre-set format for possible editing, depending on the type of publication desired. One type of publication available is electronic publication on a publicly accessible Web site sponsored by IP data processing system 100. This requires that information for all such “published” disclosures or applications be indexed and formatted for the Web. Another method of publication is creating an electronic publication document for submission to, for example, a Technical Disclosure Bulletin (TDB). Still another of publication is be to submit a Statutory Invention Registration (similar to a patent application) to the USPTO.

Still another feature of IP data processing system 100 is the document or file purge function. After a patent has issued, IP data processing system 100 provides a “purge” function that enables the system to keep copies of only certain, selected case documents. For example, in the paper world it is common to remove many documents from the patent file as soon as the patent issues. These papers may include inventor notes, marked copies of prior art references, partially completed draft patent applications and others. IP data processing system 140 provides a tool to remove all unnecessary documents from a case, either automatically or as requested. The system is configurable so that only specified Document Entities or Document Entity types (as defined by individual technology developers in the set-up function) are deleted and only specified Document Entities or Document Entity types will be retained. For example in one embodiment, after a patent issues all internal correspondence, memos, notes and patent application drafts are deleted. The system retains, for example, the invention disclosure and all documents filed in, or received from, the Patent Office.

System 100 supports payment of patent office fees for its customers in two ways: (1) withdrawals from a customer's deposit account as authorized in forms accompanying the customer's filing; and (2) check payments or wire transfers made by system 100 to patent offices 140 on the customer's behalf. System 100 includes an accounting system to track payments made on the behalf of customers' behalf in the later case and generate appropriate bills to such customers in the future. Detail required for payment of such fees can be defined during the user setup process.

Additionally, system 100 includes software that facilitates the invoicing of and payment of practitioner fees. During the user set-up process, technology developers 110, patent law firms 120 and service provides 130 define how they intend to submit to each other and provide for payment of the same. System 100 then provides, through a Web page accessible from the appropriate client system's home page, a form for charges for services to be entered. For example, system 100 provides a Web page that allows practitioner 120(x) to enter time, along with a description of tasks, spent on preparation of a patent application for technology developer 110(y). System 100 knows the billing rate for practitioner 120(x) and can therefore calculate a total invoice amount. During user set-up, practitioner 120(x) and technology developer 110(y) enter information about what sort of event triggers the sending of such invoices , e.g., on a monthly basis, upon completion of a document, upon filing a patent application, etc. When the event occurs, system 100 then generates an alert that is directed to the message/alert board of the appropriate client system (e.g., a patent administrator at technology developer 110(y). The client system can then view invoice and elect to pay or not pay it. In some embodiments, when the invoice is initially created it is associated with the Case Data Unit for the particular case and thus any client system who has access to the Case Data Unit and has permissions appropriate to view invoices may view the newly created invoice. Payment can be made by a transfer of funds from a financial institution associated with technology developer 110(y) to a financial institution associated with patent law firm 120(x). In some embodiments, system 100 charges a small percentage of the invoice amount for coordinating such payment.

In some embodiments, system 100 also charges fees to technology developers 110 for each transaction between it and a patent office. For example, fees may be charged for payment of a maintenance fee, filing a patent application and paying Issue Fees.

As described above, system 500 is entrusted with highly sensitive intellectual property documents that often represent the “crown jewels” of technology developers 110. Accordingly, system 100 has extensive security measures to ensure such information remains confidential. In some embodiments these security measures include: verifying user identity (e.g., through a user ID and password logon process, RSA's proprietary Secure ID system, a biometric device that authenticates a user according to unique physical attributes such as retinal scans or fingerprints, or other techniques) for each client system that logs onto system 100, controlling user access to resources based on permission levels as already described, encrypting sensitive data in transit over private and/or public networks (e.g., using the SSL protocol for transmissions over the public Internet and/or using other known encryption techniques, such as virtual private network (VPN) tunneling techniques), encrypting sensitive data in database 106, detecting and responding to attacks in real time and providing complete audit information to track activity, providing an external firewall that verifies all user credentials before allowing any traffic to enter the extranet and blocking all undesired and/or unknown data packets from entering system 100 providing antivirus protection.

While not discussed above, preferred embodiments of the present invention transmit patent documents over internet 50 using a secure connection between system 100 and each of the technology developers 110, patent law firms 120, service providers 130, patent offices 140, prior art databases 150 and licensees 160. Such a secure connection is beneficial in maintaining the privacy/confidentiality of the information transmitted. One well known method of ensuring such privacy is to follow the well known Secure Sockets Layer (SSL) protocol which is supported by currently up-to-date versions of both the Netscape and Microsoft Internet Explorer browsers. Another method employs public and private key encryption technology as is known in the art.

Additional Embodiments

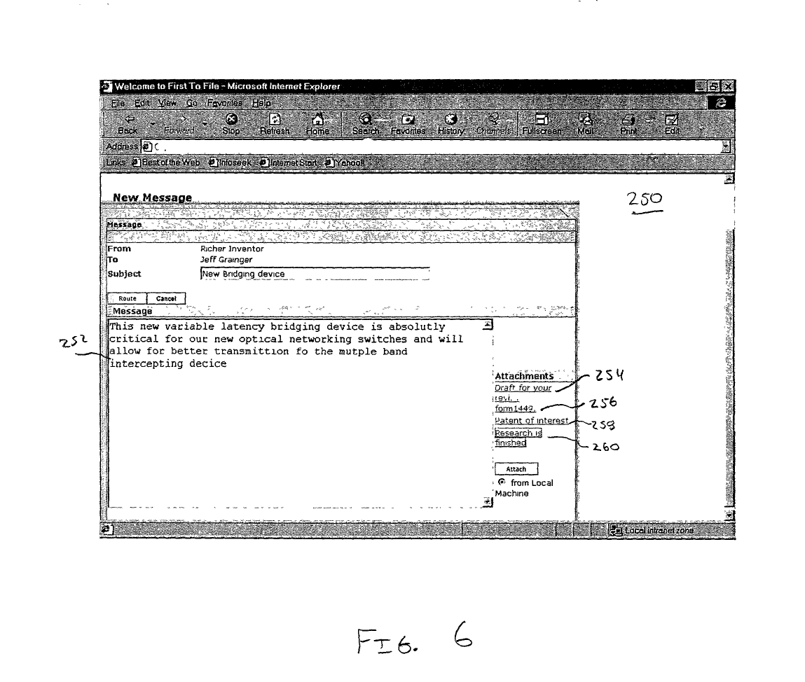

FIG. 5 illustrates another embodiment of an IP data processing system 200 according to the present invention. In FIG. 5, elements similar to those identified in FIG. 2 are given identical reference numbers. One primary difference between IP data processing system 200 and IP data processing system 100 is that instead of transmitting and receiving patent and patent application documents and other information to and from patent offices via email or regular mail, patent office personnel access such documents and other information directly through an electronic file-room 206 via a web browser. Electronic file-room 206 is part of database 106. Patent Office personnel receive alerts and messages from IP data processing system 200 whenever actionable events occur. Actionable events include, for example, filing a patent application and other formal patent documents. As previously mentioned, instead of transmitting those documents over the Internet to a patent office, IP data processing system 200 sets an internal status field within database 106 associated with the document to “filed.” System 200 then sends a message that it is received by the appropriate patent office personnel on their home page for IP data processing system 200 indicating that such a document was filed.

Having fully described several embodiments of the present invention, other equivalent or alternative methods of practicing the present invention will be apparent to those skilled in the art. For example, information on prior art databases 150 may be stored in a database directly accessible to IP data processing system 100 over a LAN or WAN rather than through the internet. These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

What is claimed is:

1. A computer-implemented method of managing documents related to a patent application, said method comprising:
storing a first workflow rule on a server system, wherein said first workflow rule causes, upon receipt of a first signal indicating a request to submit an invention disclosure for approval, the server system to generate a message that requests approval to prepare a patent application for said invention disclosure and route said message to a second client system;
storing a first invention disclosure in a database accessible by said server system;
receiving, at said server system, a first signal from a first client system indicating a request to submit said first invention disclosure for approval; and
executing said first workflow rule from said server system to generate a message requesting approval of a second client system to prepare a patent application from said first invention disclosure and to communicate said message to said second client system.

2. The method of claim 1 wherein said message is an alert that, when read, allows said second client system to select to approve or disapprove preparation of a patent application for said invention disclosure and wherein after said second client system makes a selection, stores said selection in said database.

3. The method of claim 2 wherein if said second client system selects to approve preparation of said patent application, said server system generates a second message indicating said invention disclosure has been approved for preparation of a patent application.

4. The method of claim 3 wherein said second message is communicated to a third client system associated with a patent law firm.

5. The method of claim 4 wherein said server system includes an access management system that assigns client systems to one or more user groups and assigns data and documents stored in said database to one or more user groups, and wherein said access management system allows a client system connected to said server system to access data and/or documents if the client system is assigned to the same group as the data and/or document.

6. The method of claim 5 wherein said first and second client systems are associated with a first technology developer and assigned by said server system to a first user group; said invention disclosure is part of a Case Data Unit assigned to said first user group; said third client system is assigned to a second user group different from said first user group; and, in response to said second client system approving preparation of said patent application, said server system also assigns said invention disclosure to said second group.

7. The method of claim 6 wherein said first workflow rule is defined by a work station associated with said first technology developer during a customer set-up process.

8. The method of claim 1 wherein said first client system sends said first signal to said server system over the Internet.

9. The method of claim 8 wherein said first client system uploads said invention disclosure to said server system as part of the submission process.

10. The method of claim 8 wherein said first client system creates said invention disclosure under the guidance of Web pages generated by said server system.

11. The method of claim 1 wherein said message includes a link to said first invention disclosure.

12. The method of claim 11 wherein said message also includes at least one other link to an electronic document relevant to said invention disclosure.

13. A computer-implemented method of managing documents related to a patent application, said method comprising:
storing a first workflow rule on a server system, wherein said first workflow rule causes, upon receipt of a first signal indicating a request to submit a draft patent application for approval, the server system to generate a message that requests comments on said draft application and routes said message to a second client system;
storing a first draft patent application in a database accessible by said server system;
receiving, at said server system, a first signal from a first client system indicating a request to solicit comments on said draft patent application; and
executing said first workflow rule from said server system to generate a message requesting comments on said draft patent application from a second client system and communicate said message to said second client system.

14. A server system for managing information related to patent applications, said server system comprising:
(a) a processor;
(b) a database; and
(c) a memory for storing a program;
wherein said processor is operative with said program to:
(i) allow a first client system to set-up workflow rules that define, for predetermined events, selected client systems for said server system to transmit messages to;
(ii) store, in said database, an invention disclosure submitted by a second client system; and
(iii) transmit a message to a third client system to indicate that said invention disclosure has been stored in said database;
wherein one of said predetermined events for which a workflow rule is defined is the submission of an invention disclosure by said second client system and wherein said first client system defines said workflow rule to cause said server system to transmit said message to said third client system.

15. The server system of claim 14 wherein said first client system and second client system are coupled over a local or wide area network.

16. The server system of claim 14 wherein said processor is operative with said program to further allow said third client system to store a patent application corresponding to said invention disclosure in said database and, in response to selection of a submit icon, submit electronically submit said patent application to an patent office.

17. The server system of claim 14 wherein said server system receives communications from said first client system, said second client system and said third client system over the Internet.
